(19) United States
(12) Patent Application Publication
(10) Pub. No.: US 2006/0171453 A1
(43) Pub. Date: Aug. 3, 2006

(54) Video surveillance system

(76) Inventors: Thomas R. Rohlfing, Salt Lake City, UT (US); Jeremy A. Noring, Corvallis, OR (US); Jeffrey B. Lancaster, Riverton, UT (US); Evan I. F. Tree, Sandy, UT (US); Andrew J. Hartsfield, Draper, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 11/325,204

(22) Filed: Jan. 3, 2006

Related U.S. Application Data
(60) Provisional application No. 60/641,392, filed on Jan. 4, 2005.
(60) Provisional application No. 60/661,305, filed on Mar. 10, 2005.
(60) Provisional application No. 60/681,003, filed on May 12, 2005.

(51) Int. Cl. H04N 11/04; H04N 7/18; H04N 9/47; H04N 11/02; H04N 7/12; H04B 1/66

(52) U.S. Cl. 375/240.01; 348/143; 348/152

(57) ABSTRACT

A video surveillance system includes one or more cameras communicatively coupled to a control system via a dual use medium. The video surveillance system includes a setup mode, a live viewing mode, a record mode, and a search/playback mode, some of which may operate simultaneously. In a live viewing mode, a user can view video data from one or more cameras using a graphical user interface. In the record mode, a user can independently set the record modes and schedules of the cameras, specify multiple motion detection zones per camera, and record in panic mode. In the search/playback mode, a user can search for and view, previously recorded video segments and perform file operations on the recorded video segments.

### CROSS REFERENCE TO RELATED APPLICATIONS

This application claims priority under 35 U.S.C. § 119(e) to U.S. Provisional Patent Application No. 60/641,392, titled “Video Surveillance System” to Thomas R. Rohlfing, et al., and filed Jan. 4, 2005; and to U.S. Provisional Patent Application No. 60/661,305, titled “Security Camera With Adaptable Connector For Coupling To Track Lighting And Back-Up System For Fault Tolerance” to Andrew Hartsfield, et al., filed Mar. 10, 2005; and to U.S. Provisional Patent Application No. 60/681,003, titled “Modular Design For A Security System” to Andrew Hartsfield, et al., filed May 12, 2005, the contents of each are herein incorporated by reference.

### BACKGROUND OF THE INVENTION

1. Field of the Invention

The present invention generally relates to the field of video surveillance systems, and more specifically, to software-controlled video surveillance systems.

2. Description of the Related Arts

Traditional video surveillance systems include one or more video cameras and may include, for example, associated motion detectors and other components. The video cameras, which may be networked together, are usually coupled to a central monitoring station. Many of these systems, however, can be difficult and costly to install, reducing their practicality in many markets. Each security camera must be individually mounted to a surface, such as a ceiling or wall, and usually requires wiring to provide electrical power to the camera as well as wiring to transmit the video signal from the camera to the central monitoring location. For example, installing a security system in a typical home with a plurality if cameras can require a full day for two technicians to install.

In addition to the difficulty and cost of setting up a traditional video surveillance system, transmission of streaming video over a conventional network generally exhibits some undesirable properties resulting from the unpredictability of the transport delay through the transport medium. For example, network transport times may vary from a few milliseconds to several seconds, depending on network congestion, the network route involved, and other factors. To compensate for this network unpredictability, typical video streaming viewers, usually designed for use in viewing over the Internet (e.g. Microsoft Windows® Media Player, Apple QuickTime Player®, RealOne® Player, and others), incorporate a substantial buffer between the network connection and the video being viewed. This is so that the video can be extracted from the buffer at a rate for generation of high video quality. Because of this buffering, however, the video being viewed is several seconds behind the source of the video stream. Even when the advanced user reduces the buffering delay to the shortest possible value, transport delays and connection times are quite high.

For viewing pre-recorded video, the delay means that a user must wait for several seconds before the video begins. For a system intended for viewing live-camera images, there are two significant drawbacks to this delayed approach. First, each time a connection is established between a camera and the central monitoring station, which may be, for example, a computing device, several seconds elapse before the first image appears (e.g., typically 9-15 seconds for Microsoft® Media Player). This can be confusing to a user, and the penalty for network errors is many seconds of lost video. Secondly, even after video is finally visible, the temporal lag between the live camera scene and the viewed scene is very disconcerting to a viewer who sees both the live scene and the video image, as is common with a video surveillance system.

Furthermore, most traditional video surveillance systems require a dedicated computer system to handle all of the compute-intensive tasks associated with handling multiple simultaneous video streams. Typical tasks include digitizing analog video, compressing digitized video before storage, performing motion detection, or rendering video images to a monitoring screen. These tasks can consume the available central processing unit (CPU) processing power on most modern computing devices (PC), reducing the resources available for other normal computing tasks such as word processing, spread sheet, budgeting, and other common applications.

Thus, there is a need for a low-cost video surveillance system that is user friendly, responsive to real-time viewing requirements, with low CPU usage to prevent interference with other applications, and with multiple functionalities, including, for example, live viewing, recording, and search/playback that are easily customizable by the user.

### SUMMARY OF THE INVENTION

The present invention includes systems and methods for video surveillance including: cameras that capture digital streaming full color video, and a highly user friendly control system that displays and stores video data transmitted by the cameras.

An exemplary embodiment of a video surveillance system includes: a dual use medium; a control system; a first camera; a camera transceiver communicatively coupled to the dual use medium via a low latency video connection and configured to send video data from the first camera over the dual use medium and to receive control signals over the dual use medium. The control system has a control transceiver communicatively coupled to the dual use medium, the control transceiver is configured to receive video data from the first camera via the dual use medium and to send control signals to the first camera over the dual use medium. In an exemplary embodiment, the dual use medium is the electrical power wiring of a building, which provides power to the cameras as well as a secure communication channel through which video data is transmitted to the control system. The control system includes a software application running on a computing device. Various methods and systems for initializing and operating the video surveillance system, for example, in a live viewing mode, a record mode, a search/playback mode, or a setup mode, are also a part of the present invention.

An exemplary embodiment of the first camera includes a housing and an image capture system, which is supported by the housing and generates an analog video signal. The first camera also includes a processor enclosed in the housing and coupled to the image capture system. The processor transforms the analog video signal into a video data stream, and the processor includes a motion detection module for indicating a segment of the video data stream during which a motion-based event occurred. The first camera includes a transceiver coupled to the processor for sending the video data stream over a dual use medium. In particular, in exemplary embodiments of the first camera, some of the video processing tasks are performed by the camera to reduce use of the processing resources on the computing device, allowing other applications to operate normally and seamlessly.

The features and advantages described in the specification are not all inclusive and, in particular, many additional features and advantages will be apparent to one of ordinary skill in the art in view of the drawings, specification, and claims. Moreover, the language used in the specification has been principally selected for readability and instructional purposes, and may not have been selected to delineate or circumscribe the inventive subject matter.

### BRIEF DESCRIPTION OF THE DRAWINGS

The patent or application file contains at least one drawing executed in color. Copies of this patent or patent application publication with color drawings will be provided by the Office upon request and payment of the necessary fee.

The invention has other advantages and features which will be more readily apparent from the following detailed description of the invention and the appended claims, when taken in conjunction with the accompanying drawings, in which:

FIG. 1 is a block diagram of one embodiment of a video surveillance system of the present invention.

FIG. 2A is a block diagram of one embodiment of the computing system of the video surveillance system of FIG. 1.

FIG. 2B is a block diagram of one embodiment of an image capture system of the video surveillance system of FIG. 1.

FIG. 3A is a block diagram of one embodiment of the memory of the computing system of FIG. 2A.

FIG. 3B is a block diagram of one embodiment of the memory of the image capture system of FIG. 2B.

FIG. 4 is a functional diagram of a data flow for operation of the memory of FIG. 3A.

FIGS. 5A and 5B are graphical representations of an exemplary graphical user interface for performing system setup for one embodiment of the video surveillance system of the present invention.

FIG. 5C is a graphical representation of another exemplary graphical user interface for performing system setup for another embodiment of the video surveillance system of the present invention.

FIGS. 6A, 6B, and 6C are graphical representations of exemplary graphical user interfaces for a live viewing mode of one embodiment of the video surveillance system of the present invention.

FIG. 7 is a graphical representation of an exemplary graphical user interface for a search/playback mode of one embodiment of the video surveillance system of the present invention.

FIG. 8 is a flowchart of an exemplary embodiment of an initialization process for a video surveillance system of the present invention.

FIG. 9 is a flowchart of an exemplary embodiment of an operating process for a video surveillance system of the present invention.

FIG. 10 is a flowchart of an exemplary embodiment of a live viewing mode of a video surveillance system of the present invention.

FIG. 11 is a flowchart of an exemplary embodiment of a record mode of a video surveillance system of the present invention.

FIG. 12 is a flowchart of an exemplary embodiment of a search/playback mode of a video surveillance system of the present invention.

FIG. 13 is a front view of one embodiment of a video surveillance camera of the present invention.

FIG. 14 is a block diagram of the components of the video surveillance camera of FIG. 13.

FIG. 15A is a color photograph of a camera image in which the camera has adjusted the image quality based on the camera image as a whole.

FIG. 15B is a color photograph of a camera image in which the camera has adjusted the image quality based on an event in a motion detection zone.

### DETAILED DESCRIPTION OF THE PREFERRED EMBODIMENTS

Reference will now be made in detail to several embodiments of the present invention, examples of which are illustrated in the accompanying figures. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. Wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

In particular, systems and methods for video surveillance systems are described. The description of the present invention is in the context of a system for a video surveillance system used in a home and includes a system for viewing, recording, searching, and playing video data. The system is also responsive to events associated with the video surveillance process. It will be apparent, however, to one skilled in the art that the invention can be practiced without these specific details, and home video surveillance is just an example of the application of the principles of the present invention. In other instances, structures and devices are shown in block diagram form to avoid obscuring the invention. However, the present invention applies to any video data processing system that has video data such as medical video image processing, video monitoring of testing centers, test subjects, and businesses, or other video data processing systems for other purposes, and video surveillance of homes is only used here by way of example.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the present invention claimed below is operating on, or working in conjunction with, an information or computing system. Such a computing system as claimed may be an entire video surveillance system or only portions of such a system. For example, the present invention can operate with a computing system that need only be a digital camera in the simplest sense to process and store video data. Thus, the present invention is capable of operating with any computing system from those with minimal functionality to those providing all the functionality disclosed herein.

System Overview

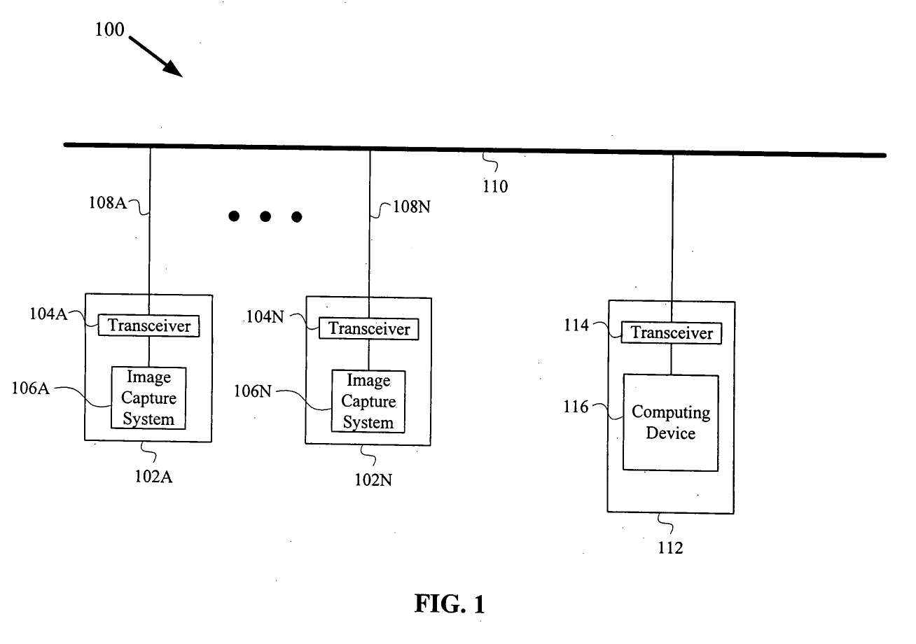

FIG. 1 is a block diagram of one embodiment of a video surveillance system 100 of the present invention. The video surveillance system 100 includes one or more cameras 102A-102N, each electrically and communicatively coupled to a dual use medium 110 via a respective connection 108A-108N. Each camera 102A-102N includes an image capture system 106A-106N to produce video data and a transceiver 104A-104N to prepare the video data for sending over the dual use medium 110 via the connections 108A-108N. For example, the transceivers 104A-104N may encrypt outgoing data and decrypt incoming data. Each image capture system 106A-106N includes, for example, a lens, a charge coupled device (CCD), and associated electronics. The dual use medium 110 may be, for example, a power line in a building, such as a home or business, that provides both power to the cameras 102A-102N and a communication channel for video data from the cameras 102A-102N via the connections 108A-108N.

Also coupled to the dual use medium 110, is a control system 112. The control system 112 includes a transceiver 114 to receive the video data for processing by a computing device 116 running a software application to control the video surveillance system 100. The transceiver 114 may encrypt outgoing data and decrypt incoming data. The transceiver 114 includes, for example, a USB Receiver Module with built-in surge protection that plugs directly into a wall outlet near the PC 116. A USB cable connects the USB Receiver Module to an available USB port on the PC 116.

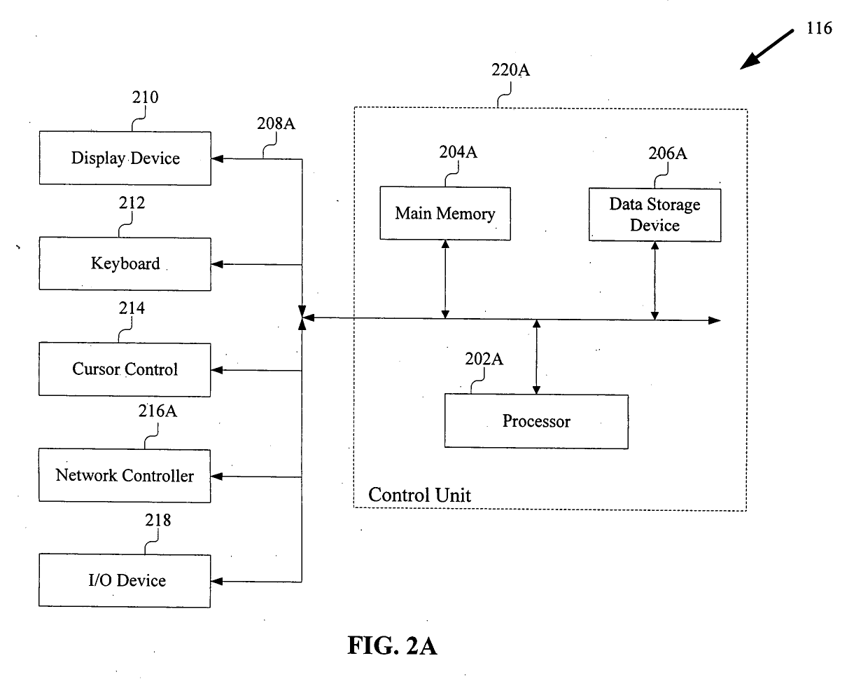

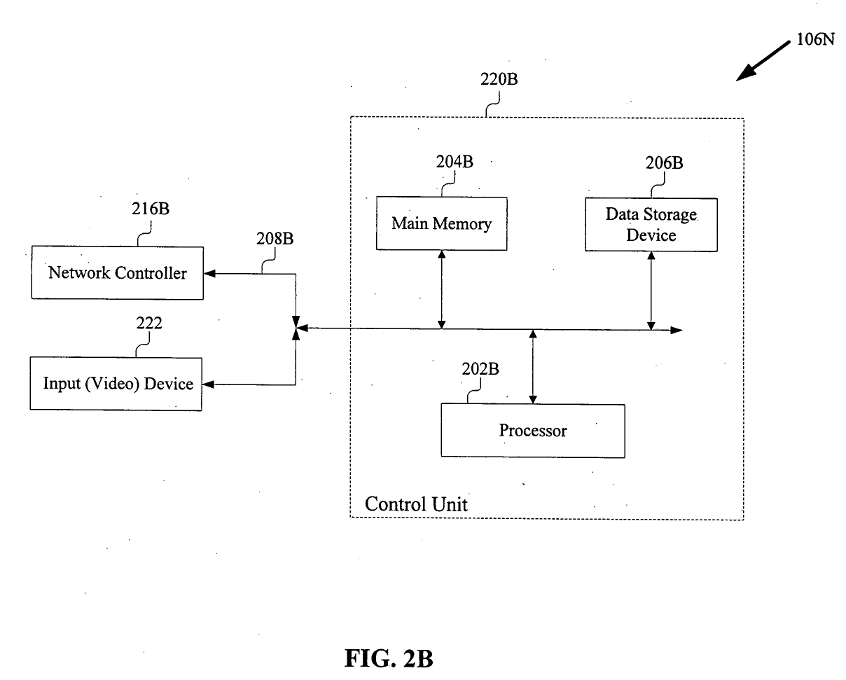

FIG. 2A is a block diagram of one embodiment of the computing device 116 of the video surveillance system 100 of FIG. 1. The computing device 116 comprises a control unit 220A, a display device 210, a keyboard 212, a cursor control 214, a network controller 216A, and one or more I/O device(s) 218.

The control unit 220A may comprise an arithmetic logic unit, a microprocessor, a general purpose computer, a personal digital assistant, or some other information appliance equipped to provide electronic display signals to the display device 210. In one embodiment, the control unit 220A comprises a general purpose computer having a graphical user interface, which may be generated by, for example, a program written in Java running on top of an operating system like WINDOWS® or UNIX® based operating systems. In one embodiment, one or more application programs are executed by the control unit 220A including, without limitation, word processing applications, electronic mail applications, financial applications, and web browser applications.

The control unit 220A is shown including a processor 202A, a main memory 204A, and a data storage device 206A, all of which are communicatively coupled to a system bus 208A.

The processor 202A processes data signals and may comprise various computing architectures including a complex instruction set computer (CISC) architecture, a reduced instruction set computer (RISC) architecture, or an architecture implementing a combination of instruction sets. Although only a single processor is shown in FIG. 2A, multiple processors may be included.

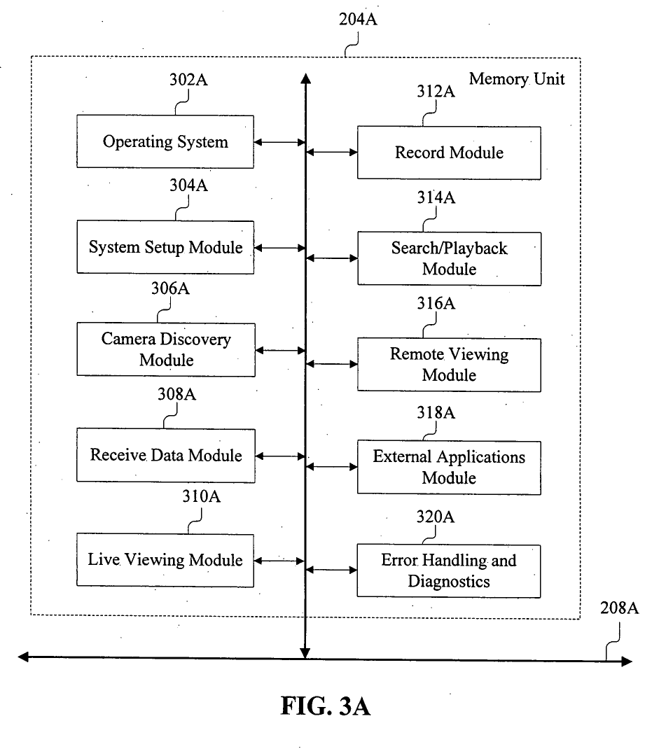

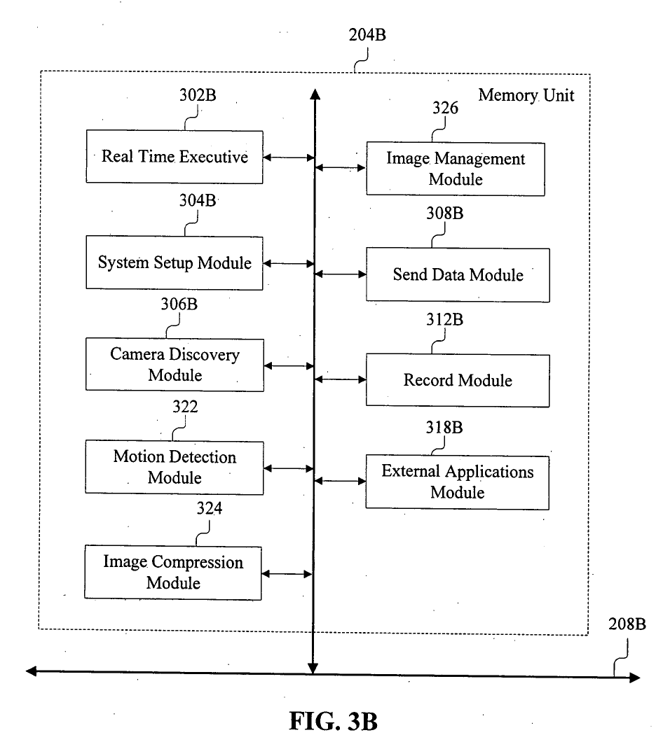

The main memory 204A stores instructions and/or data that may be executed by the processor 202A. The instructions and/or data may comprise code for performing any and/or all of the techniques described herein. The main memory 204A may be a dynamic random access memory (DRAM) device, a static random access memory (SRAM) device, or some other memory device known in the art. The main memory 204A is described in more detail below with reference to FIG. 3A. In particular, the portions of the main memory 204A for initializing and operating the video surveillance system 100 will be described.

The data storage device 206A stores data and/or instructions for the processor 202A and comprises one or more devices including a hard disk drive, a floppy disk drive, a CD-ROM device, a DVD-ROM device, a DVD-RAM device, a DVD-RW device, a flash memory device, or some other mass storage device known in the art. The data storage device 206A may include a database for storing video data electronically.

The system bus 208A represents a shared bus for communicating information and data throughout the control unit 220A. The system bus 208A may represent one or more buses including an industry standard architecture (ISA) bus, a peripheral component interconnect (PCI) bus, a universal serial bus (USB), or some other bus known in the art to provide similar functionality. Additional components coupled to the control unit 220A through the system bus 208A include the display device 210, the keyboard 212, the cursor control 214, the network controller 216A, and the I/O audio device(s) 218.

The display device 210 represents any device equipped to display electronic images and data. The display device 210 may be, for example, a cathode ray tube (CRT), liquid crystal display (LCD), or any other similarly equipped display device, screen, or monitor.

The keyboard 212 represents an alphanumeric input device coupled to the control unit 220A to communicate information and command selections to the processor 202A.

The cursor control 214 represents a user input device equipped to communicate positional data as well as command selections to the processor 202A. The cursor control 214 may include a mouse, a trackball, a stylus, a touch screen, cursor direction keys, or other mechanisms to cause movement of a cursor.

The network controller 216A links the control unit 220A to a network that may include multiple processing systems. The network of processing systems may comprise a local area network (LAN), a wide area network (WAN) (e.g., the Internet), and/or any other interconnected data path across which multiple devices may communicate. The control unit 220A also has other conventional connections to other systems such as a network for distribution of data using standard network protocols such as TCP/IP, http, and SMTP as will be understood to those skilled in the art. The network controller 216A can be used to couple the video surveillance system 100 to a video data storage device, and/or other computing systems.

One or more I/O devices 218 are coupled to the system bus 208A. For example, the I/O device 218 may be a microphone for input and transmission of audio output via speakers. Optionally, the I/O audio device 218 may contain one or more analog-to-digital or digital-to-analog converters, and/or one or more digital signal processors (DSP) to facilitate processing.

FIG. 2B is a block diagram of one embodiment of an image capture system 106N of the video surveillance system 100 of FIG. 1. Although reference is made specifically to the image capture system 106N, this is merely for convenience and the discussion applies equally to any of the image capture systems 102A-102N of the cameras 102A-102N. The image capture system 106N as shown in FIG. 2B includes some components similar to the computing device 116 shown in FIG. 2A. Similar components are denoted by similar reference numerals. The image capture system 106N comprises a control unit 220B communicatively coupled to an input video device 222 and a network controller 216B via a system bus 208B.

Like the control unit 220A of the computing device 116, the control unit 220B of the image capture system 106N may comprise an arithmetic logic unit, a microprocessor, a microcontroller, or some other information appliance equipped to provide electronic signals to, and to receive electronic signals from, the input video device 222. In one embodiment, the control unit 220B comprises an integrated circuit DSP to provide control signals to the input video device 222.

The control unit 220B is shown including a processor 202B, a main memory 204B, and a data storage device 206B, all of which are communicatively coupled to the system bus 208B. Like the processor 202A of FIG. 2A, the processor 202B processes data signals and may comprise any of the various computing architectures described above with respect to the processor 202A. Like the main memory 204A of FIG. 2A, the main memory 204B stores instructions and/or data that may be executed by the processor 202B and may comprise any of the various embodiments described above with respect to the main memory 204A. The instructions and/or data may comprise code for performing any and/or all of the techniques described herein. The main memory 204B, particularly portions for initializing and operating the video surveillance system 100, is described in more detail below with reference to FIG. 3B. Like the data storage device 206A of FIG. 2A, the data storage device 206B stores data and/or instructions for the processor 202B and may comprise any of the embodiments described above with respect to the data storage device 206A. Like the system bus 208A of FIG. 2A, the system bus 208B represents a shared bus for communicating information and data throughout the control unit 220B and may comprise any of the embodiments described above with respect to the system bus 208A.

The input video device 222 is coupled to the system bus 208A for input and transmission of video data. Optionally, the input video device 222 may include one or more analog-to-digital or digital-to-analog converters, and/or one or more digital signal processors to facilitate video processing.

Like the network controller 216A of FIG. 2A, the network controller 216B is coupled to the system bus 208B and acts as a data interface. The network controller 216B links the control unit 220B to a network to facilitate transmission of video data from the image capture system 106N of the camera 102N.

It should be apparent to one skilled in the art that the control units 220A, 220B may include more or less components than those shown in FIGS. 2A and 2B without departing from the spirit and scope of the present invention. For example, the control units 220A, 220B may include additional memory, such as, for example, a first or second level cache, or one or more application specific integrated circuits (ASICs). Furthermore, the control unit 220B may not include the data storage device 206B.

Software Architecture

FIG. 3A is a block diagram of one embodiment of the memory 204A of the computing device 116 of FIG. 2A. In particular, the portions of the memory 204A needed for the initialization and operation of the video surveillance system 100 according to the present invention are shown and will now be described more specifically. Those of skill in the art will appreciate that, in an alternative embodiment, the modules described in FIG. 3A may reside in the data storage device 206A rather than the memory 204A.

As shown in FIG. 3A, the memory 204A comprises: an operating system 302A, a system setup module 304A, a camera discovery module 306A, a receive data module 308A, a live viewing module 310A, a record module 312A, a search/playback module 314A, a remote viewing module 316A, an external applications module 318A, and an error handling and diagnostics module 320A, all coupled for communication with each other and with the control unit 220A by the bus 208A.

The operating system 302A is preferably one of a conventional type such as, WINDOWS®, MAC®, SOLARIS® or LINUX® based operating systems. Although not shown, the memory 204A may also include one or more application programs including, without limitation, word processing applications, electronic mail applications, financial applications, and web browser applications.

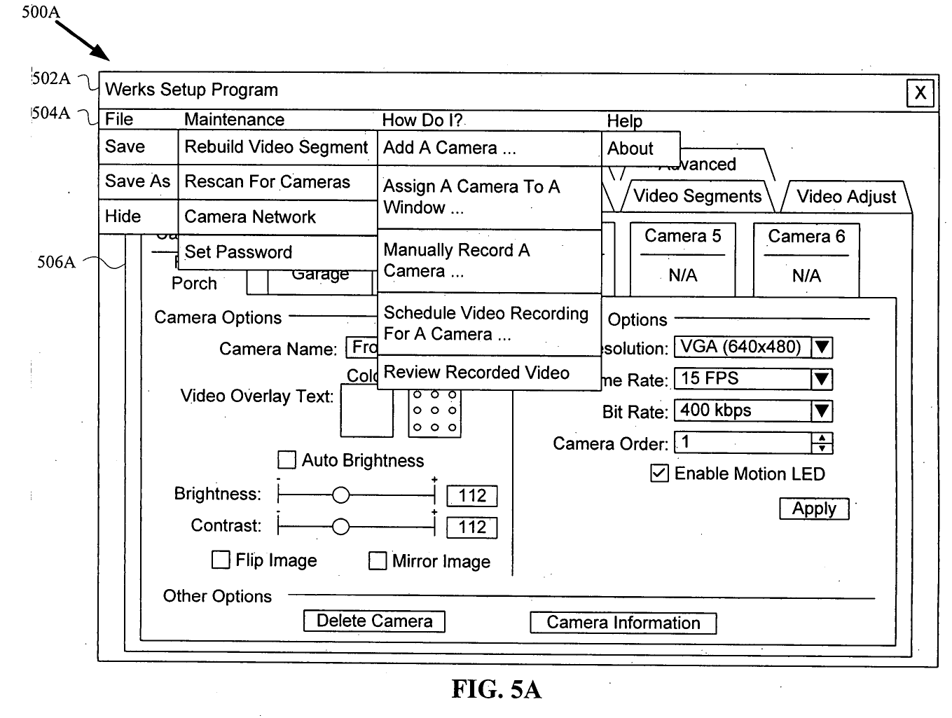

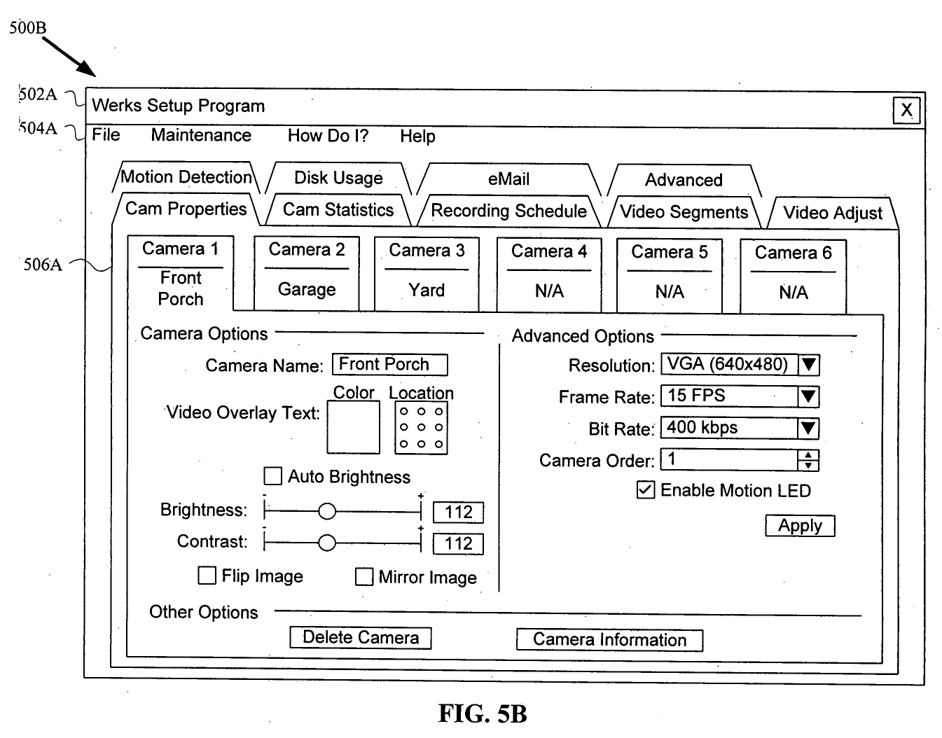

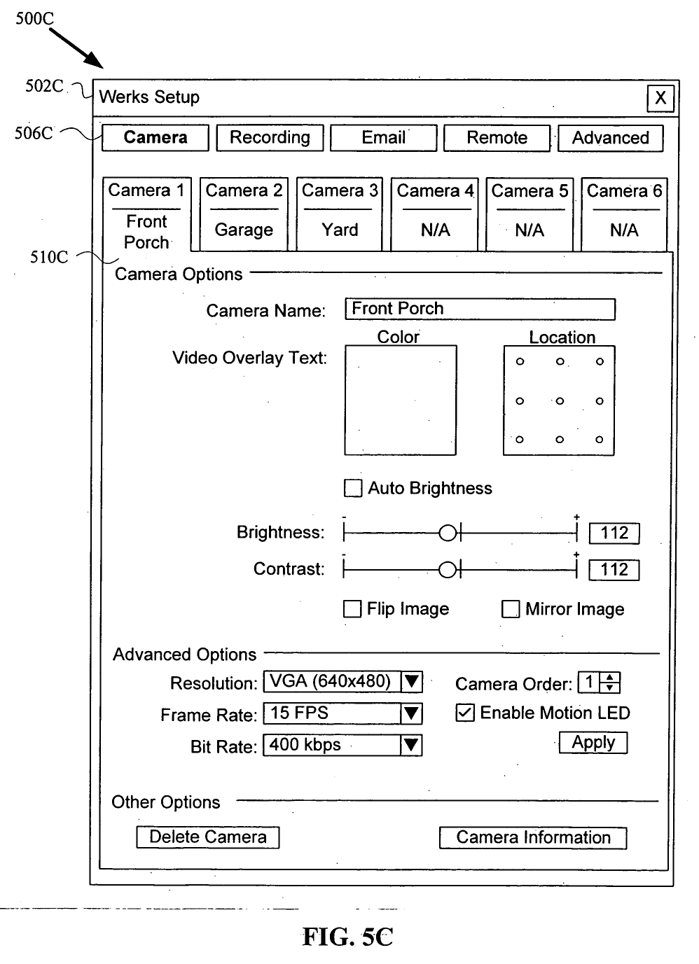

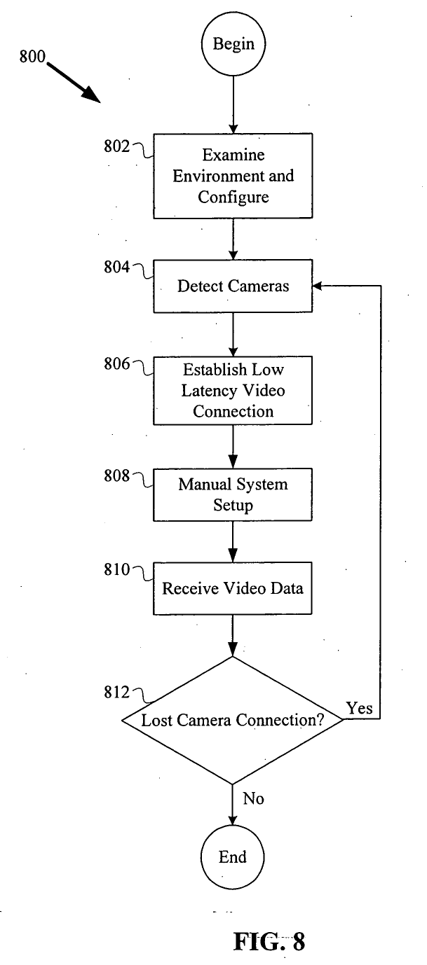

The system setup module 304A is for initializing the video surveillance system 100 in accordance with the present invention. The system setup module 304A is responsive to the control environment and to input to the video surveillance system 100 and in response determines initial system parameters for the video surveillance system 100. The system setup module 304A is coupled to the camera discovery module 306A to determine the presence of the cameras 102A-102N, and it communicates with the live viewing module 310A, the record module 312A, and the search/playback module 314A to provide initial system setup parameters. The system setup module 304A preferably includes at least one wizard for automatically detecting and setting the operating parameters of the camera(s) 102N and the control system 112. The operation of the system setup module 304A will be described in more detail below with reference to FIGS. 5A-5B and FIG. 8.

The camera discovery module 306A is coupled to the system setup module 304A and detects the presence of the cameras 102A-102N in the video surveillance system 100. The camera discovery module 306A also facilitates reestablishing connection to a particular camera 102A-102N when its connection 108A-108N is broken. The operation of the camera discovery module 306A will be described in more detail below with reference to FIG. 8.

The receive data module 308A processes video data received from the cameras 102A-102N over the dual use medium 110. The receive data module 308A converts the video data signal from the format used to transmit over the dual use medium 110 into a format proper for processing by the control unit 220A. In particular, the receive data module 308A interfaces with the live viewing module 310A and the record module 312A, both of which process the video data. The receive data module 308A may also decrypt the video data signal if encryption is being used. The operation of the receive data module 308A will be described in more detail below with reference to FIG. 8.

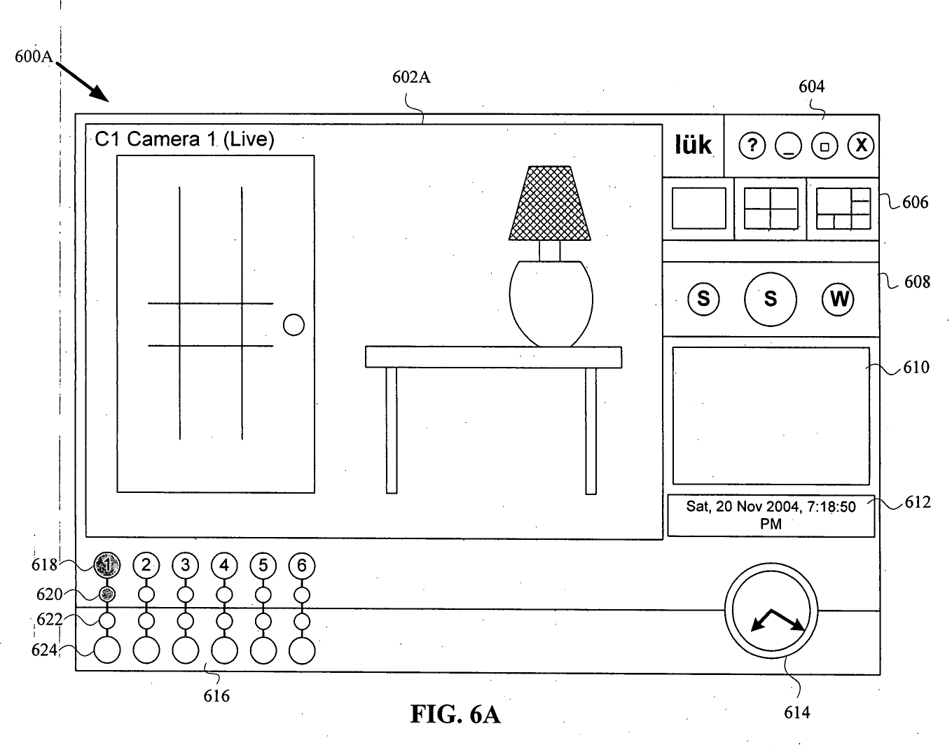

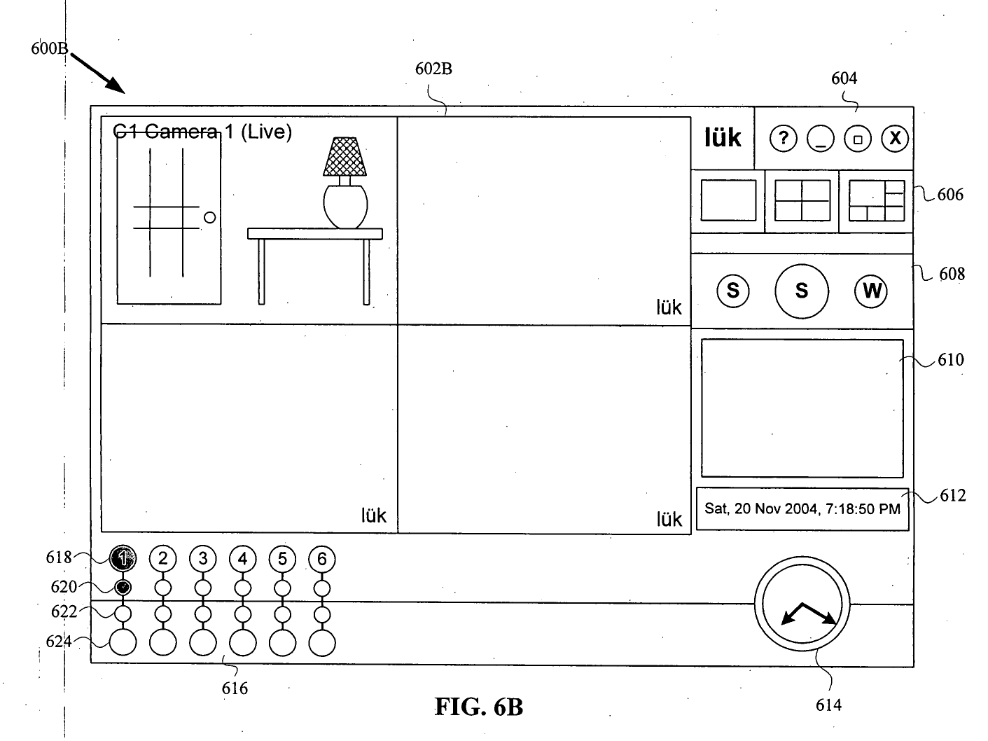

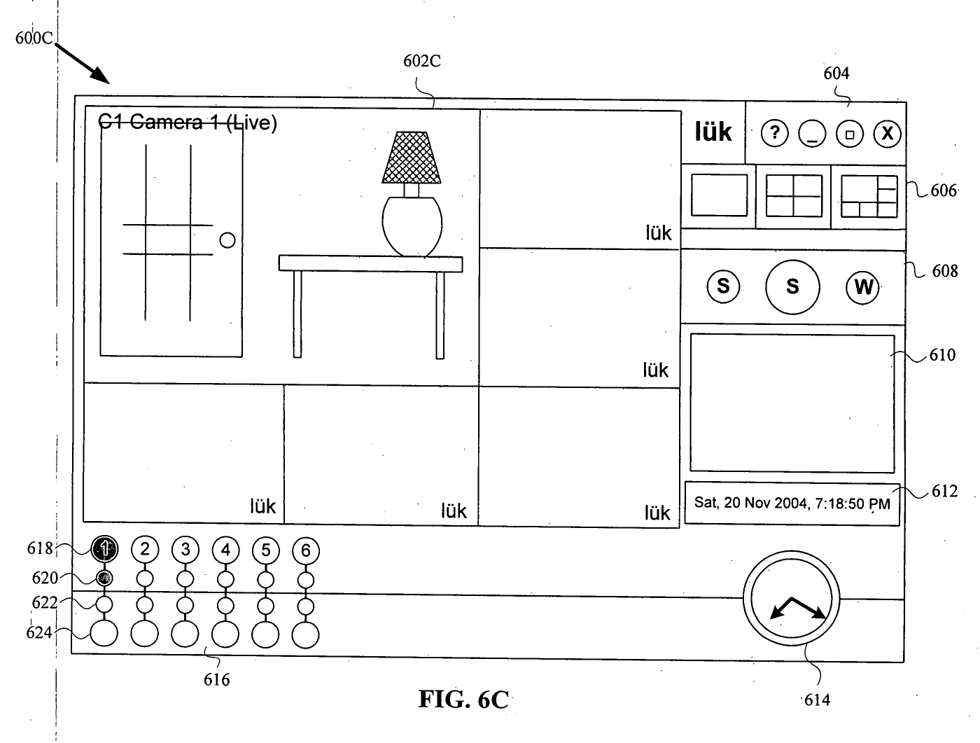

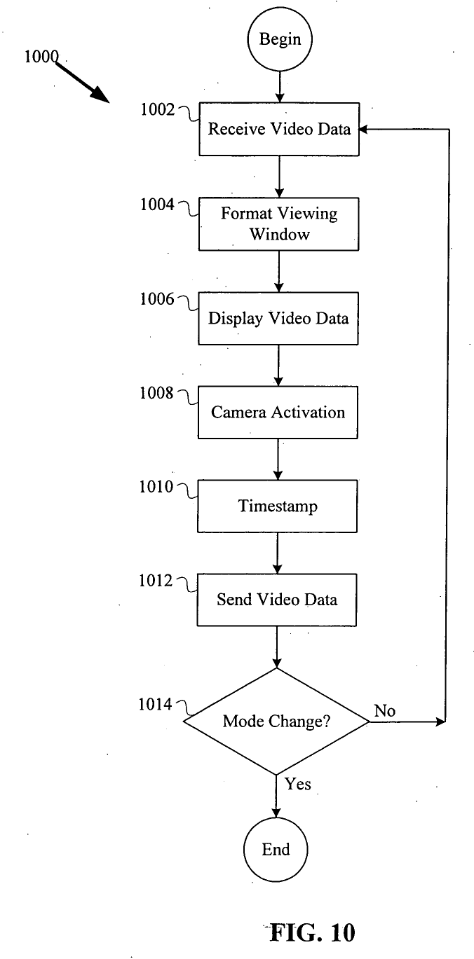

The live viewing module 310A works in conjunction with the receive data module 308A to provide live viewing of the video data received by the receive data module 308A. The live viewing module 310A provides a graphical user interface that allows a user to interact with the video surveillance system 100. In particular, the live viewing module 310A facilitates activation and deactivation of the cameras 102A-102N, changing of the viewing window format, changing of system parameters, access to the record mode, and access to the search/playback mode. The operation of the live viewing module 310A will be described in more detail below with reference to FIGS. 6A-6C and FIG. 10.

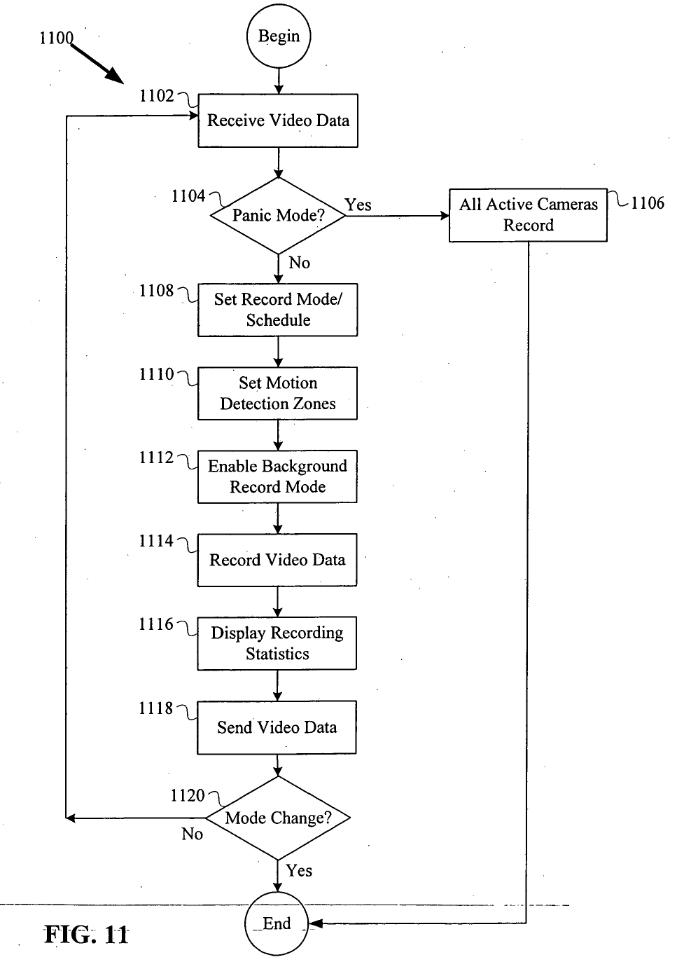

The record module 312A works in conjunction with the receive data module 308A to record the video data received by the receive data module 308A. The record module 312A is responsive to user input to set the recording schedule for each camera 102A-102N, to set motion detection zones, and to allow recording in panic mode. The operation of the record module 312A will be described in more detail below with reference to FIG. 11.

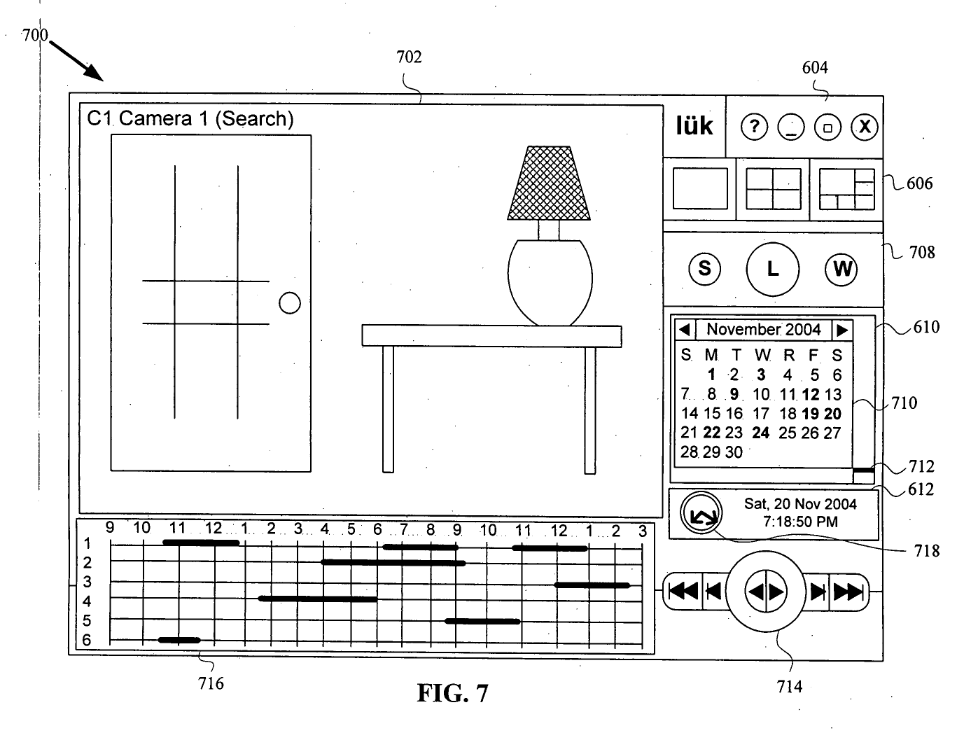

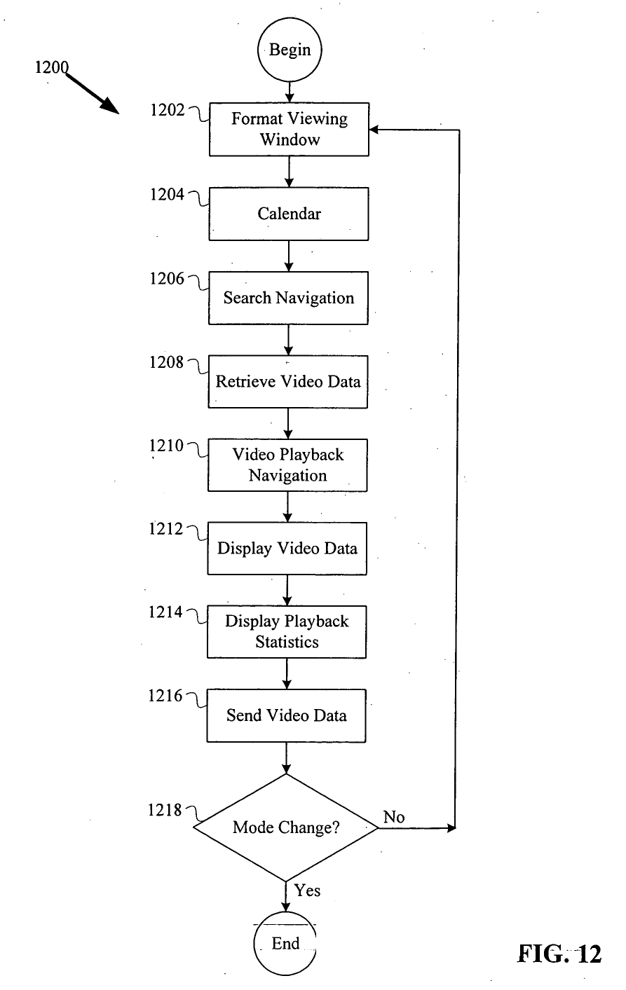

The search/playback module 314A is coupled to the data storage device 206A to allow searching and playback of previously recorded video data. The search/playback module 314A provides a graphical user interface that allows a user to interact with the video surveillance system 100. In particular, the search/playback module 314A facilitates searching through previously recorded video data segments, playback of particular selected video segments, changing of the viewing window format, changing of system parameters, access to the record mode, and access to the live viewing mode. The operation of the search/playback module 314A will be described in more detail below with reference to FIG. 7 and FIG. 12.

The remote viewing module 316A works in conjunction with the network controller 218 and the receive data module 308A to send the video data received by the receive data module 308A to a remote location to facilitate remote viewing of the video data. The remote viewing module 316A may include several functionalities. For example, the remote viewing module 316A captures video frames from the video pipeline. It may perform conversion from the current video pipeline frame rate to a frame rate, which may be higher or lower than the video pipeline frame rate, suitable for remote streaming. The remote viewing module 316A may perform resampling of the video data format (i.e., pixel resolution) from the video pipeline video format to a data format suitable for remote streaming. This data format is usually lower than the video pipeline format, but not necessarily. For one-camera view modes, the remote viewing module 316A may perform selection of which camera, out of N, is to be streamed for remote viewing at a particular moment in time. This can be either a fixed selection, or the remote viewing module 316A can cycle through the N cameras, or through M selected cameras out of N, one at a time. For multi-camera view modes, the remote viewing module 316A may assemble mosaic formats, such as a 2×2 mosaic, of multiple camera images into a single video stream for remote viewing. Lastly, the remote viewing module 316A may communicate with a remote viewing server to provide status of the video surveillance system 100 and/or the cameras 102A-102N. Those of skill in the art will appreciate that this list of functionalities is not exclusive and that not all of these functionalities will be used under all conditions.

The external applications module 318A allows the video surveillance system 100 to provide video and control interfaces to other associated applications. The external applications module 318A works in conjunction with the receive data module 308A to facilitate sending of the video data received by the receive data module 308A to the external applications. The external applications module 318A may also work in conjunction with the network controller 218 to send the data to remote applications. As an example, a second computing device, such as a PC running the Windows XP® Media Center Edition (MCE) operating system, may be connected to the user's television or another video display system. The MCE PC can be interfaced to the video surveillance system 100 over a LAN or other network. A software module running on the MCE PC provides a user interface for the user to control the video surveillance system 100 remotely from the MCE PC, to view video data from the cameras 102A-102N, and/or to be notified of motion events, among other functionalities. For example, if the user is watching a television program using the MCE PC and a large screen TV, the external applications module 318A would allow a message to pop up saying “Camera 3 has detected motion. Do you wish to see this video?” Alternatively, the external applications module 318A would enable the video data to appear in a picture-in-picture window for a period of time. Thus, the MCE PC provides a mechanism to watch and control the video surveillance system 100 using the TV and the MCE PC. Those of skill in the art will appreciate that this example of an external application communicating with the video surveillance system 100 via the external applications module 318A to provide expanded system-wide functionality is merely illustrative, and other scenarios are possible.

The error handling and diagnostics module 320A works in conjunction with several of the preceding modules to handle and diagnose errors, for example, regarding data transmission or communication. For example, the error handling and diagnostics module 320A may work with the camera discovery module 306A in the event of a lost connection 108A-108N to a camera 102A-102N. As another example, the error handling and diagnostics module 320A may work with the receive data module 308A in the event of an incomplete data stream.

FIG. 3B is a block diagram of one embodiment of the memory 204B of the image capture system 106N of FIG. 2B. In particular, the portions of the memory 204B needed for the initialization and operation of the camera 102N are shown and will now be described more specifically. Although reference is made specifically to the camera 102N, this is merely for convenience and the discussion applies equally to any of the cameras 102A-102N. Those of skill in the art will appreciate that, in an alternative embodiment, the modules described in FIG. 3B may reside in the data storage device 206B rather than the memory 204B.

As shown in FIG. 3B, the memory 204B comprises several modules, some of which operate similarly to modules in the memory 204A of FIG. 3A: a real time executive 302B, a system setup module 304B, a camera discovery module 306B, a motion detection module 322, an image compression module 324, an image management module 326, a send data module 308B, a record module 312B, and an external applications module 318B, all coupled for communication with each other and with the control unit 220B by the bus 208B.

The real time executive 302B is a conventional type known to those skilled in the art and controls interaction among the other modules of memory 204B.

The system setup module 304B is for initializing the camera 102N. The system setup module 304B is responsive to the environment and determines initial system parameters for the camera 102N. The system setup module 304A is coupled to the camera discovery module 306A to trigger an announcement of the presence of the camera 102N, and it communicates with the record module 312A to provide initial system setup parameters. Additionally, the system setup module 304A includes an update capability, for receiving updated system parameters and distributing them to the other modules in memory 204B. Furthermore, in an alternative embodiment, a user can independently interact with the system setup module 304B to alter system parameters. As will be apparent to one skilled in the art, the operation of the system setup module 304B is similar to that described below with reference to FIG. 8.

The camera discovery module 306B is coupled to the system setup module 304B and signals the presence of the camera 102N in the video surveillance system 100. The camera discovery module 306B also facilitates re-announcing the presence of the camera 102N when its connection 108N is broken. As will be apparent to one skilled in the art, the operation of the camera discovery module 306B is similar to that described below with reference to FIG. 8 but for the signals that need to be sent from the camera 102n to the control system 112.

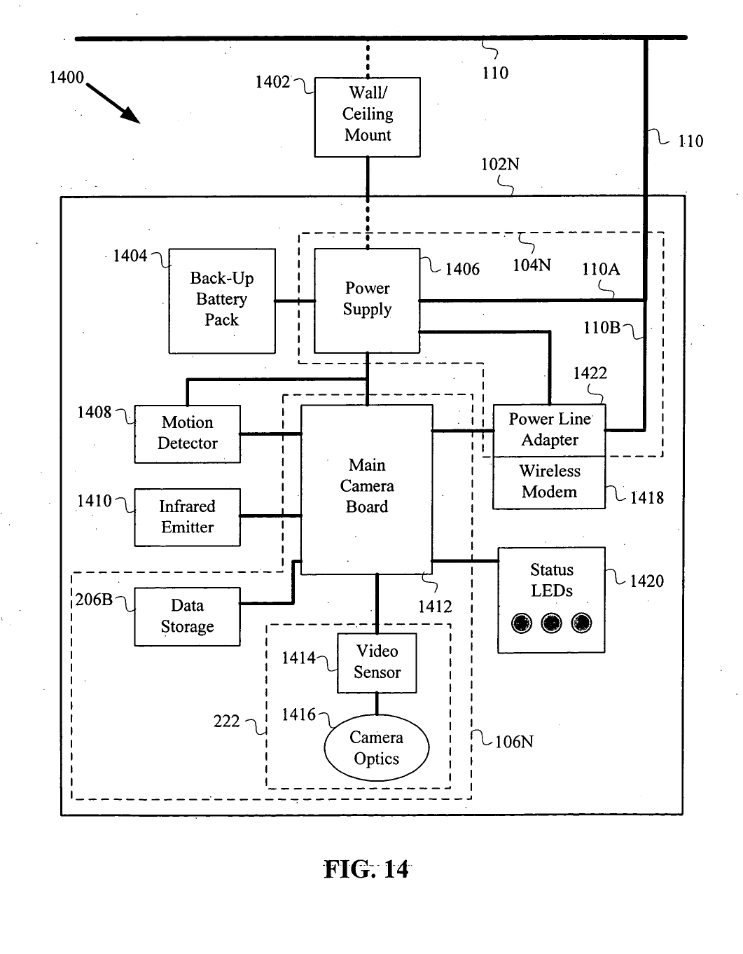

The motion detection module 322 is responsible for identifying video frames in which motion is detected. The motion detection module 322 is coupled to the send data module 308B to send the motion detection signal along with the transmitted video data signal. In another embodiment, the motion detection module 322 works in conjunction with the send data module 308B described below to control transmission of the video data so that the video data is only sent from the camera 102N to the computing device 116 over the dual use medium 110 when there is motion detected, allowing the video surveillance system 100 to conserve bandwidth when there is no motion detected. As will be apparent to one skilled in the art, the operation of the motion detection module 322 enables the motion detection feature described below with reference to FIG. 11 and FIG. 14.

The image compression module 324 is responsible for compressing the video data signal prior to transmitting it over the dual use medium 110. The operation of the send data module 308B will be described in more detail below with reference to FIG. 14.

The image management module 326 controls image quality of the video data. For example, the image management module 326 may affect such parameters as automatic brightness, resolution, and bit rate. The operation of the image management module 326 will be described in more detail below with reference to FIG. 11 and FIG. 14.

The send data module 308B is responsible for network communication, for example, using an internet protocol (IP) stack, to transmit the video data signal over the dual use medium 110. In particular, the send data module 308B encrypts the video data signal if encryption is being used. The send data module 308B also interfaces with the record module 312B to provide the video data to the record module 312B for local recording, if necessary. The operation of the send data module 308B will be described in more detail below with reference to FIG. 14.

The record module 312B locally records the video data received by the image capture system 106N, if necessary. The record module 312B is coupled to the system setup module 304B to receive such parameters as the default record mode and motion detection zones. As will be apparent to one skilled in the art, the operation of the record module 312B is similar to that described below with reference to FIG. 11.

The external applications module 318B works in conjunction with the send data module 308B to send the data to remote applications, such as applications that may be located in the memory 204A of the computing device 116. Another example of an external application might be Windows® Media Player running on an external PC, in which a user enters a Uniform Resource Locator (URL) that identifies one of the cameras 102A-102N to view video data from the identified camera 102A-102N.

Methods are described below, particularly with respect to the flowcharts of FIG. 8-FIG. 12, regarding the initialization and operation of the video surveillance system 100, and the live viewing, record, and search/playback modes of the video surveillance system 100. The methods are presented particularly with respect to the embodiment of the video surveillance system 100 including the memory 204A of the computing device 116 as shown in FIG. 3A. Those of skill in the art will realize that the methods described, particularly the methods of FIG. 8 and FIG. 11 regarding the initialization and record mode of the video surveillance system 100, with minor modifications, can also be used with the memory 204B of the image capture system 106N as shown in FIG. 3B.

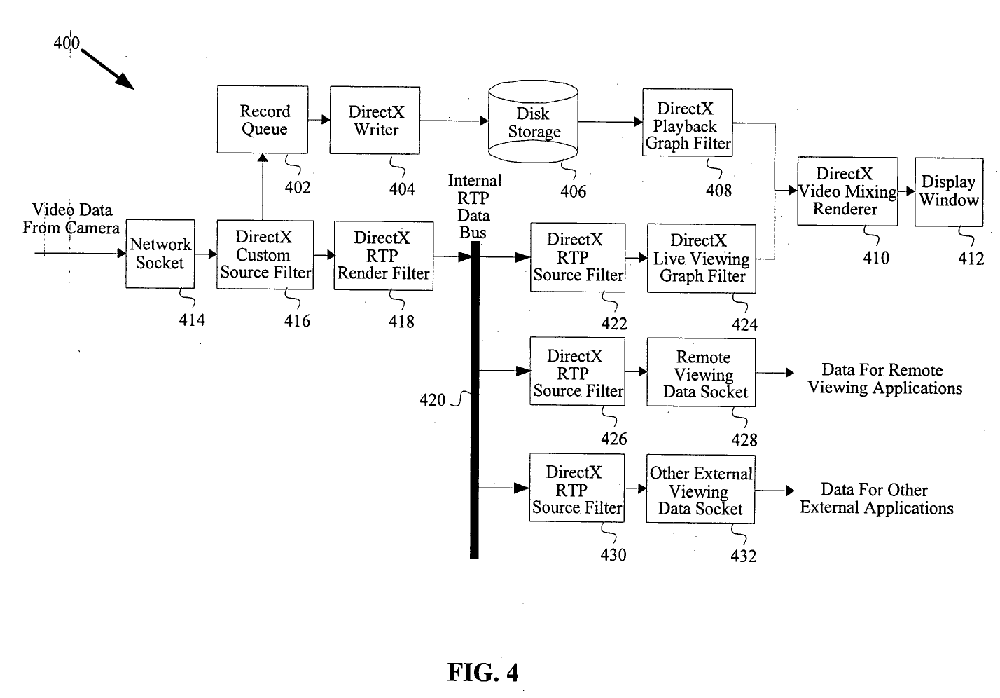

FIG. 4 is a functional diagram of a data flow 400 for operation of the memory 204A of the computing device 116 of FIG. 3A. The data flow 400 represents the data flow for a single camera 102N. Each camera 102A-102N connected to the video surveillance system 100 would have a data flow similar to data flow 400.

Video data from a camera 102N is presented to a network socket 414, for example, via an Ethernet network IP socket connection. The network socket 414 accomplishes the transfer of video data from the camera 102N to the rest of the data flow 400, using, for example, either TCP/IP or UDP/IP Ethernet packets. The network socket 414 also implements a retry and recovery mechanism in the event of network failures or errors.

A DirectX custom source filter 416 receives the video data stream from the network socket 414. The video data from the camera 102N is received as standard Ethernet packets. This packet data is combined into video frames, where each frame has a header, plus the video information for each frame. The header contains time stamp information, a frame type, and information about motion detection, if any, for that frame.

The frame type may be, for example, a Key frame or I frame. Most modern video compression schemes that achieve very high compression rates use a combination of Key frames and I frames. A Key frame is a stand-alone video frame, which can be rendered without any other information from previous frames. On the other hand, an I frame contains primarily information about how this particular I frame differs from the previous frame. Consequently, I frames are typically much smaller than Key frames, resulting in greater data compression. There are typically several I frames between Key frames, resulting in significant data reduction.

The output of the DirectX custom source filter 416 is DirectX video frames, which are transmitted to a record queue 402, to a DirectX RTP render filter 418, or to both. In one embodiment, the frames of the video data stream (i.e. the sequence of video frames) are encoded using the Microsoft Windows® Media 9 compression format; however, the frames can also be encoded in any popular video format such as MJPEG, MPEG-2, MPEG-4, or other formats.

The DirectX RTP render filter 418 receives video frames as input data and repackages these video frames into an RTP data stream and sends the data stream via the Internal RTP data bus 420. The DirectX RTP render filter 418 sends video data as RTP data packets via bus 420 to any registered destinations, such as the DirectX RTP source filters 422, 426, and 430.

If live viewing is active, the DirectX RTP source filter 422 registers itself as a destination for the RTP render filter 418 and then receives video frames via the RTP data bus 420. The DirectX RTP source filter 422 receives the RTP data packets, extracts the individual video frames from the RTP stream, and passes these video frames to the DirectX live viewing graph filter 424. If live viewing is not active, no data is sent to the DirectX RTP source filter 422 and subsequent blocks.

The DirectX live viewing graph filter 424 processes the video frames and prepares them for presentation to the DirectX video mixing renderer (VMR) 410. The VMR 410 includes the Windows® Media 9 decoder function, which creates full video frames from the compressed sequence of Key frames and I frames. It also superimposes text and graphics information over the video images. The resultant displayable image is then rendered onto the surface of a designated display window 412. Each camera 102A-102N has a designated display window 412.

Video data from the camera 102N that is received by the DirectX custom source filter 416 is also sent to the record queue 402. The record queue 402 is used to deal with the video compression format, which reduces network bandwidth by using a combination of Key frames and I frames. For example, a user might wish to start recording at the moment motion is detected in the camera 102N. But, due to the Key/I frame composition of the compressed video data stream, a new recording must begin with a Key frame, since I frames cannot be rendered without the previous sequence of frames, back to the previous Key frame. The record queue 402 stores the most recent set of frames, back to the most recent Key frame, or perhaps back a multiple number of Key frames if more information is stored in the record queue 402. Thus, when recording is to start, the recording can begin at a Key frame prior to the trigger point. The temporary storage performed by the record queue 402 may be organized as a software queue.

The DirectX writer 404 receives video data from the record queue 402 until the record queue 402 is empty, and thereafter, the DirectX writer 404 receives video data directly from the DirectX custom source filter 416. When recording is initiated, the processor 202 supplies a filename to the DirectX writer 404, which then writes a standard Windows® Media 9 (.wmv) data file under the designated disk filename in the disk storage 406. A particular feature of the present invention is that recording can start and stop as required, without disturbing the flow of video frames to the live viewing data path if live viewing is active.

A significant benefit derived from storing the recorded video data as standard Windows® Media 9 (.wmv) files is that the recorded video files can be played using the standard Windows® Media Player, and they can be viewed as thumbnail images in the Windows® Explorer. The recorded video files do not require the video surveillance system 100 for viewing. Thus, if a video clip is sent via email to some other location, it can be viewed using standard Windows® software components without requiring the video surveillance system 100 to be installed as a viewer.

When in search mode, the DirectX playback graph filter 408 receives a filename corresponding to the file the user has selected for playback. The DirectX playback graph filter 408 opens the file and begins playing the file by sending video frames to the VMR 410, which renders the displayable video image to the designated display window 412, similarly to the process used for live viewing. The user can specify a playback file position within the file, which is translated by the DirectX playback graph filter 408 from an absolute playback time to a time relative to the start of the particular recorded file.

The DirectX playback graph filter 408 also supports playback at rates other than normal (1×) playback speed. The DirectX playback graph filter 408 is responsible for sending each frame on to the VMR 410 at the correct time, according to the time stamp included with each video frame at the time it was acquired in the camera 102N, and according to the current playback rate (i.e., speed).

The internal RTP data bus 420 provides a flexible means of distributing video samples from the camera 102N to multiple destinations. These destinations might include the live viewing display window 412, a remote viewing connection, or another external viewing application. If remote viewing is active, the DirectX RTP render filter 418 sends the video frames via the data bus 420 to the DirectX source filter 426, which sends the video data to a remote viewing data socket 428 to transmit the data to a remote viewing application. If video data is intended for other external applications, the DirectX RTP render filter 418 sends the video frames via the data bus 420 to the DirectX source filter 430, which sends the video data to an external viewing data socket 432 to transmit the data to an external application such as a Microsoft Media Center PC.

As an example of remote viewing, the remote viewing data socket 428 of the video surveillance system 100 facilitates monitoring of nearly-live video data feeds from the cameras 102A-102N over the Internet. A user can specify one or more remote viewing locations, for example, Windows® Mobile enabled cell phones, handheld devices, Internet browsers on remote computing devices at a second home or office, and other devices that support Windows® Media 9 video. Examples of compatible cell phones include the Anextek SP230, Palm Treo 700w, and HP iPAQ hw6500 series. Examples of compatible wireless handled devices include the Asus MyPal A730W and Toshiba e805. Examples of compatible Internet browsers include Microsoft® Internet Explorer. Several such remote viewing locations may be enabled. When remote viewing is enabled, the computing device 116 acts as a video server ready to publish video from the secure environment created using the dual use network 110, over the Internet, to the remote viewing location.

One important consideration with the implementation of the RTP data bus 420 and the RTP render filter 418 is that destinations can be added or deleted without disturbing the operation of other destinations. For example, the DirectX RTP source filters 426, 430 can register themselves as destinations for the RTP render filter 418 without disrupting other operations of the data flow 400. In other words, the live viewing and/or recording do not have to temporarily halt while a remote viewing connection or external application destination is added or deleted. If remote or external viewing are not active, no data is sent to the DirectX RTP source filters 426, 430 and subsequent blocks.

Initialization and Operation of the Video Surveillance System

FIG. 8 is a flowchart of an exemplary embodiment of an initialization process 800 for the video surveillance system 100 of the present invention. The initialization process 800 is used, for example, with the memory 204A of the computing device 116 of FIG. 3A. Those of skill in the art will appreciate that the modules described in the initialization process 800 of FIG. 8 are not exclusive and need not be performed in the order described.

A significant advantage of the video surveillance system 100 of the present invention is ease of installation, which is accomplished in part using two wizards to help users make simple choices. When the memory 204A is first configured, for example, by installation via compact disk (CD), an installation wizard handles conventional tasks such as installing device drivers and copying required files to their proper destinations. When the video surveillance system 100 is operated for the first time, another wizard examines 802 the user's computer environment and sets up the remaining required items that are machine-dependent. This includes, for example, determining video disk storage location, and setting up parameters for a power line network, in the case where the dual use medium 110 is a building power line. Unless the user wishes to change a setting from the defaults suggested by the installation wizards, no user action is required other than to simply accept each suggestion.

Another way in which the video surveillance system 100 is characterized by ease of installations is through use of the dual use medium 110 to create a separate dedicated environment for the video surveillance system 100. Traditional networked cameras and computers can be difficult to set up properly due to the need to co-exist with other networked devices. These difficulties are avoided in the video surveillance system 100 through use of the dual use medium 110. The cameras 102A-102N operate in their own separate dedicated environment and can co-exist with conventional network devices. For example, where the dual use medium 110 is a building power line system, few homes will have pre-existing power line networks, which means the examination 802 process can determine address assignments and settings without worrying about compatibility with other devices. A separate network interface connection (NIC) is created on the computing device 116 to service the environment of the video surveillance system 100.

Another consideration addressed during the examination step 802 of the initialization process 800 is firewall handling, which also contributes to the ease of installation. Many computers contain built-in firewalls, which present a difficult issue for computer peripheral components used in networked systems, such as the video surveillance system 100. Many users may not know what firewall(s) are present or how to configure them. During the examination 802 of the computer environment, special test functions are used to detect and display helpful information to the user regarding firewalls. Such information includes (1) whether any firewall is preventing proper operation of the video surveillance system 100, and (2) what type of traffic is currently being blocked (e.g., UDP broadcast, UDP P-P, TCP P-P, and Universal Plug and Play). For the most popular firewall programs, a message is displayed to the user, notifying the user of the presence of the particular firewall.

For some common firewall programs, for example, the built-in Windows XP® firewall, the installation wizard used in the examination 802 step can automatically reconfigure the firewall to allow the video surveillance system 100 to operate normally. If such automatic reconfiguration is not possible, the installation wizard invokes a help system that displays information telling the user how to reconfigure the firewall to permit operation of the video surveillance system 100. This directed troubleshooting process performs the most difficult parts of the task for the user—determining that there is a firewall problem and what needs to be changed in the firewall setup—and provides appropriate information to the user.

The initialization process 800 also includes a system to automatically detect 804 cameras 102A-102N. The video surveillance system 100 employs the industry standard Universal Plug and Play (UPnP) protocol to establish a connection between the cameras 102A-102N and the control system 112, in particular the memory 204A. The UPnP protocol provides reliable discovery and control between units operating on a common network segment (e.g., network 110).

When the cameras 102A-102N are first turned on, each announces its presence over the dual use medium 110 with a UPnP “notify” message. The cameras 102A-102N continue to do so periodically, according to the UPnP protocols. Similarly, as part of the initialization process 800, UPnP “search” messages are sent out by the control system 112, requesting that any cameras 102A-102N announce their presence. This UPnP discovery process provides a very reliable means of automatically detecting 804 the presence of the cameras 102A-102N in the video surveillance system 100. The user simply plugs in a camera 102A-102N to a power outlet and connects the PC 116 to the dual use medium 110 (e.g., a power line) through the transceiver 114 (e.g., a USB power line adapter).

Once a camera 102A-102N is detected, the initialization process 800 establishes 806 a low latency video connection (e.g., connection 108A-108N) with the camera 102A-102N. The architecture combines DirectX components with custom software components to achieve the low latency video connection 108A-108N as the interface between the camera 102A-102N and control system 112. Connection times are generally about one second, and typical steady-state latency times are on the order of one-third to one-half second. The connection time is longer than the steady-state latency because the control system 112 must wait for the next Key frame to come from the camera 102A-102N, which may occur about every one second. In one embodiment, the control system 112 may request the camera 102A-102N to send a Key frame on demand, so that no waiting is required, reducing the connection time. The reduced connection and steady-state latency times provide the feel of a “real-time” video connection, which is possible due to elimination of the conventional network buffer. Elimination of the conventional buffer is feasible because the video surveillance system 100 employs a dedicated communication environment via the dual use medium 110, which allows a much tighter control of latency than traditional networks such as the Internet can provide.

If a connection 108A-108N to a camera 102A-102N is “lost” 812 due to some temporary problem with the connection 108A-108N, the detect 804 camera step sends out new search messages to attempt to reestablish the connection 108A-108N to the camera 102A-102N. This particular portion of the initialization process 800 remains active throughout the operation of the video surveillance system 100 to address lost camera connections that may occur at any time during operation.

A user can accept the default configuration suggested by the installation wizards during the examine environment and configure step 802. Alternatively, a user can choose to modify parameters via a manual system setup 808, which includes a graphical user interface described in more detail below with reference to FIGS. 5A-5B.

The initialization process 800 receives 810 video data from all cameras 102A-102N detected 804 on the dual use medium 110. The video data from the cameras 102A-102N is sent as a special digitally-encoded data stream over the dual use medium 110 to the control system 112. To enhance security for the video data, a system password entered by the user, as described above, is used as an encryption key for the video data on the dual use medium 110. Without this encryption key, the video data cannot be decrypted or viewed by another party, even if they gain physical access to the user's dual use medium 110, which may be a power line, and can “see” the video data.

The initialization process 800 of FIG. 8 was described particularly in the context of the memory 204A of the computing device 116 of FIG. 3A. Those of skill in the art will appreciate that, with minor modifications, the modules described in the initialization process 800 of FIG. 8 may also apply for use with the memory 204B of the image capture system 106N of FIG. 3B. For example, the examine 802 environment step may be used to configure the camera 102N for local recording in the absence of the existence of the control system 112. The detect camera 804 step may control sending of the “notify” message in accordance with the UPnP protocol, while the lost camera connection 812 step may control resending of the “notify” message. The system setup 808 may be accomplished via firmware hard-coded into the camera 102N, and may include settings such as a default record mode and default motion detection zones. Lastly, the receive video data 810 step may in fact be a send video step to facilitate transfer of the video data to a remote viewing client or application. Other modifications may also suggest themselves to those of skill in the art.

FIGS. 5A and 5B are graphical representations of exemplary graphical user interfaces 500A and 500B for performing system setup 808 for one embodiment of the video surveillance system 100 of the present invention. The graphical user interfaces 500A and 500B include a title bar 502A, menu options 504A, and setup program tab screens 506A. The title bar 502A indicates the name of the open program, e.g., the Werks Setup Program. The “X” icon at the right of the title bar 502A closes the program when it is selected.

As shown in FIG. 5A, the menu options 504A provide access to features through the options File, Maintenance, How Do I?, and Help. Under the File menu option, the Save option saves the modified settings in a settings file. The Save As option allows the user to specify a different settings filename. The Hide option closes the application window, but keeps the application open in the system tray, allowing any recording activity to continue.

Under the Maintenance menu option, the Rebuild Video Segment option examines all video files in the video surveillance system 100 directories and rebuilds the segment list. This action is appropriate if a user suspects an error in the list of video segments. The Rescan For Cameras option initiates the detect cameras 804 step to rescan the dual use medium 110 to detect and show all cameras 102A-102N connected to the dual use medium 110. The Camera Network option allows a user to view and modify settings for the camera network, e.g., the power line network established via the dual use medium 110. For example, the user can monitor data rates and view the power line network nodes (e.g., cameras 102A-102N and USB adapters for the control system 112). The Set Password option allows a user to specify a password. A password may be used to access certain maintenance functions and to prevent inadvertent changes to, or shutdown of, the video surveillance system 100. The password also serves as an encryption key, which will be discussed further below.

Under the How Do I? menu option, various options provide instructions regarding how to Add A Camera to the network, Assign A Camera To A Window, Manually Record A Camera, Schedule Video Recording For A Camera, and Review Recorded Video. Under the Help menu option, the About option displays company and system version information.

The setup program tab screens 506A of the graphical user interface 500A provide access to features through various tab screens, such as Cam Properties, Cam Statistics, Recording Schedule, Video Segments, Video Adjust, Motion Detection, Disk Usage, eMail, and Advanced. As shown in FIG. 5B, on the Cam Properties tab screen, the user can view and edit the properties for the selected camera 102A-102N, such as the camera name, the color and location of video overlay text, the brightness and contrast, resolution, frame rate, bit rate, and other properties. On the Cam Statistics tab screen, the user can view the video and connection statistics for the selected camera 102A-102N. Video statistics may include image height, width, and target bit rate. Connection statistics may include frames per second, bit rate kbps, received frames, received packets, received bytes, received Key frames, connection time, maximum frame size, missed frames, and reconnects.

On the Recording Schedule tab screen, the user can change the recording mode and edit the recording schedule for the cameras 102A-102N. On the Video Segments tab screen, the user can view a list of recorded video events near the selected time. On the Video Adjust tab screen, the user can adjust video settings, such as brightness, contrast, quality, and sharpness, for the selected camera 102A-102N. An Auto checkbox, if selected, allows the selected camera 102A-102N to activate a built-in algorithm to seek automatic brightness and contrast settings, based on the camera's environment.

On the Motion Detection tab screen, the user can create new motion detection zones, delete old motion detection zones, or modify existing motion detection zones for the cameras 102A-102N. The user can also modify settings relating to the capturing and recording of video segments. For example, the default setting for motion detection sensitivity is pre-programmed into the firmware on the cameras 102A-102N; however, the user can modify the Sensitivity to influence how sensitive the motion triggering algorithm is to motion. A low Sensitivity setting will require more motion to trigger recording.

On the Disk Usage tab screen, the user can view statistics on the disk allocation for the saved video files, such as video path, free space, maximum allocation, current usage, and discard date. The user can indicate how much disk space to allow the video surveillance system 100 to use on the computer's hard drive. For example, a user with a 100 GB drive may wish to allocate 20 GB to video storage. The video files are stored under a common root directory, which can be designated by the user. Each camera 102A-102N has its own subdirectory under the root video directory, where the video files are stored. There may be hundreds or thousands of video files in each camera's directory. As a default, each file is given a unique filename according to a sequential numbering algorithm (e.g., F_{—}000001, F_{—}000002, etc.).

When the user's designated disk quota is reached, existing video files are deleted to make room for new video files, starting with the oldest file among all of the cameras 102A-102N. The user can designate any video file as “protected,” which will make that file read-only in the operating system and also set a flag in the internal file structure to prevent automatic deletion of the protected video file if the disk quota is reached. Such protected files are shown as red in the search mode timeline, discussed in detail below, instead of the normal green segment indication.

On the eMail tab screen, the user can specify local eMail account information and desired eMail destinations. On the Advanced tab screen, the user can view and edit advanced properties for the selected camera 102A-102N, such as horizontal and vertical offset, resolution (Res) amounts, and the bit rate type and amount.

FIG. 5C is a graphical representation of another exemplary graphical user interface 500C for performing system setup 808 for another embodiment of the video surveillance system 100 of the present invention. The graphical user interface 500C is similar to the graphical user interface 500A of FIGS. 5A and 5B, and includes a title bar 502C and setup program tab screens 506C. The title bar 502C indicates the name of the open program, e.g., Werks Setup, and includes an “X” icon at the right of the title bar 502C to closes the program. In the graphical user interface 500C, the setup program tab screens 506C provide access to features through various tab screens, including Camera, Recording, Email, Remote, and Advanced. The Camera tab screen is similar to the Cam Properties tab screen of FIG. 5B, and allows the user to view and edit the properties for the selected camera 102A-102N, such as the camera name, the color and location of video overlay text, the brightness and contrast, resolution, frame rate, bit rate, and other properties. The Recording, Email, and Advanced tab screen operate similarly to the similarly named setup program tab screens 506A of FIG. 5B. The Remote tab screen of the setup program tab screens 506C allows the user to view and change parameters associated with remote viewing locations.

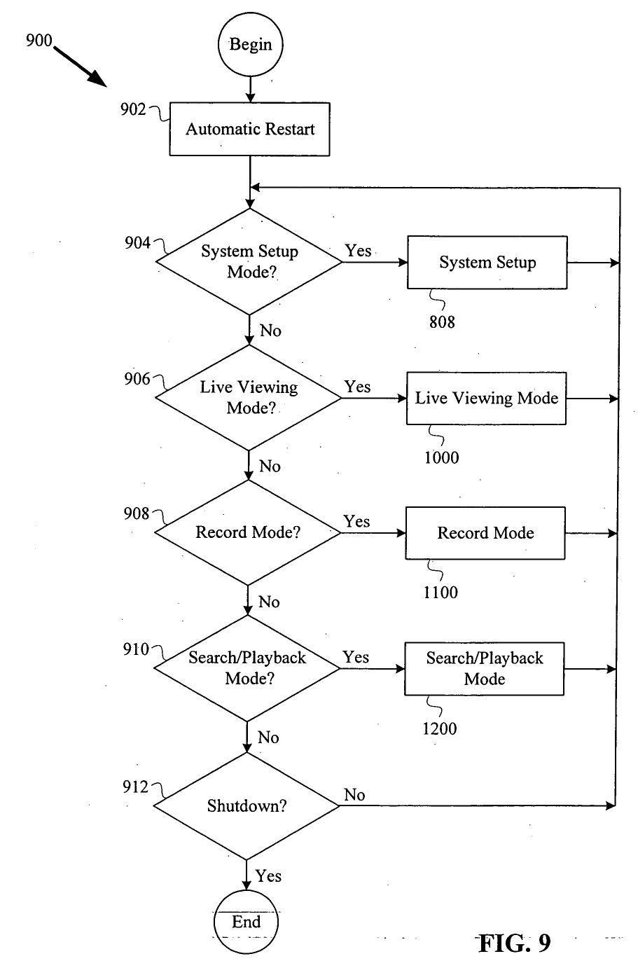

The options described with respect to the graphical user interfaces 500A and 500C are available initially during the system setup 808 of the initialization process 800. The options are also available to the user, however, via the same graphical user interfaces 500A and 500C, during regular operation of the video surveillance system 100 for further customization of the video surveillance system 100, as will be discussed with respect to FIG. 9. Some of the features accessible through the system setup 808 are specific to particular operating modes of the video surveillance system 100 and are discussed in more detail below with respect to those modes. For example, the options available through the Recording Schedule and Motion Detection tab screens of FIG. 5B are specific to the record mode of the video surveillance system 100 and are discussed in more detail with respect to FIG. 11.

FIG. 9 is a flowchart of an exemplary embodiment of an operating process 900 for the video surveillance system 100 of the present invention. The operating process 900 provides for an automatic restart 902 of the video surveillance system 100 under two conditions: daily, or as a result of inactivity. For example, the video surveillance system 100 operates under a standard operating system, such as Windows®, and therefore, there may be many other applications installed and/or operating simultaneously with the video surveillance system 100. Because of this somewhat uncontrolled environment, care must be taken to maximize the ability of the video surveillance system 100 to continue its video surveillance and recording functions. Additionally, the video surveillance system 100 may be installed in a remote location (e.g., a second home or vacation cabin), where user intervention is not convenient when problems occur.

To improve reliability, the video surveillance system 100 can be configured to terminate and restart its operation at a set time each day. The video surveillance system 100 can typically shut down and be fully operational in less than fifteen seconds, minimizing any down time, while providing a fresh start each day. This feature can be disabled or enabled by the user, and the time of restart can be set by the user.

The video surveillance system 100 Watchdog Timer is an additional reliability mechanism. The operating process 900 is continually monitoring and executing its normal functions with a background executive scheduler. If, for some reason, the executive scheduler becomes inactive for a period of time (e.g., 30 seconds), the Watchdog Timer will terminate and restart the video surveillance system 100 using the same restart mechanism that is used for the daily program restart. Thus, the video surveillance system 100 can detect problems in its own execution and recover without user intervention.

Operation of the video surveillance system 100 includes four main modes: system setup, live viewing, record, and search/playback. If the user desires to change the system setup 904, the operating process 900 enters the system setup 808 described previously with respect to FIG. 8. If live viewing 906 is desired, the operating process 900 enters a live viewing mode 1000. If recording 908 is desired, the operating process 900 enters a record mode 1100. If search/playback 910 is desired, the operating process 900 enters a search/playback mode 1200. Termination of the system setup 808, the live viewing mode 1000, record mode 1100, or the search/playback mode 1200 allows the user to enter another operating mode of the video surveillance system 100. If the user wishes to shutdown 912 the video surveillance system 100, the operating process 900 is terminated.

Those of skill in the art will appreciate that the modules described in the operating process 900 of FIG. 9 are not exclusive and need not be performed in the order described. Additionally, while the operating process 900 of FIG. 9 shows the exclusive operation of each of the operating modes, those of skill in the art will appreciate that some modes may operate simultaneously. For example, the video surveillance system 100 may be operating in the record mode 1100 and also operating simultaneously in any one of the live viewing mode 1000, the search/playback mode 1200, or the system setup 808. Other permutations may also be possible. Each of the live viewing, record, and search/playback modes will be described in greater detail below.

Those of skill in the art will appreciate that, with minor modifications, operating process 900 of FIG. 9 may also apply for the image capture system 106N of FIG. 3B. For example, the operating process 900 of FIG. 9 may minimally include the automatic restart 902, system setup 904, 808, record mode 908, 1100, and shutdown 912 modules for use with the memory 204B of the image capture system 106N of FIG. 3B. Other modifications may also suggest themselves to those of skill in the art.

Live Viewing Mode

FIG. 10 is a flowchart of an exemplary embodiment of a live viewing mode 1000 of the video surveillance system 100 of the present invention. Those of skill in the art will appreciate that the steps described in the live viewing mode 1000 of FIG. 10 are not exclusive, need not all be performed in all instances of live viewing, and need not be performed in the order described.

The live viewing mode 1000 of the video surveillance system 100 receives 1002 video data from all of the cameras 102A-102N over the dual use medium 110. The video data received may be encrypted for additional system security as described above with respect to receiving video data 810 of FIG. 8.

The live viewing mode 1000 includes steps necessary to process the received video data, including formatting 1004 a viewing window, displaying 1006 the video data, controlling camera activation 1008, and displaying a timestamp 1010 associated with the received data. Each of these steps is described in greater detail with reference to FIGS. 6A, 6B, and 6C below.

The live viewing mode 1000 also provides support for sending 1012 video data, for example, by eMail, to alternative destinations under certain events or conditions. As discussed above with respect to system setup 808 of FIG. 8 and FIG. 5B, the user can specify local eMail account information (e.g., account, server, and password) and also designate one or more recipients for eMail notification, via the eMail tab screen. Having specified desired eMail destinations, the user can manually send the current live image to the recipient(s). Alternatively, the video data can be sent to a remote viewing location or application via the DirectX RTP source filter 426 and remote viewing data socket 428.

If the user wishes to change modes 1012, the live viewing mode 1000 terminates, returning the user to the operating process 900 of FIG. 9.

FIGS. 6A, 6B, and 6C are graphical representations of exemplary graphical user interfaces 600A, 600B, and 600C for the live viewing mode 1000. In the live viewing mode 1000, the graphical user interfaces 600A-600C allow a user to monitor what the cameras 102A-102N are capturing and possibly recording. One of the graphical user interfaces 600A-600C, depending on how many cameras 102A-102N are detected, is the first screen the user sees when launching the video surveillance system 100. The following discussion focuses primarily on graphical user interface (GUI) 600A of FIG. 6A, with reference to GUI 600B of FIG. 6B and GUI 600C of FIG. 6C where appropriate.

The live viewing mode GUI 600A is straightforward and intuitive, with a minimum of unnecessary or advanced controls, and includes title bar application options 604, main screen feature buttons 608, a viewing window 602A, multiple camera view selectors 606, a message window 610, a date/time stamp window 612, a current time clock 614, and a camera activation panel 616. The GUI 600B and the GUI 600C are identical to the GUI 600A, except for differently configured viewing windows 602B and 602C, respectively.

The title bar application options 604 includes four buttons to allow the user to control various application options of the video surveillance system 100. Selection, for example, by clicking, of the help button, marked with a question mark, opens a help system for the video surveillance system 100. The help system allows the user to access topics by clicking through a Table of Contents, searching using a Search option, or browsing through a comprehensive Index. Selection of the minimize button, marked with an underscore, collapses the GUI 600A to the task bar of the computing device 116. Selection of the full screen button, marked with a box, allows the user to view the GUI 600A without the GUI controls, i.e., showing only the video images. Selection of the exit button, marked with an “X,” closes the GUI 600A, but does not terminate the operation of the video surveillance system 100. In particular, clicking on the exit button displays a system message, for example, “The application will continue to run and record to the DVR. If you wish to exit the application, right-click on the icon in the system tray and select the Exit option.”

The main screen feature buttons 608 include three buttons to allow the user to change the operating mode of the video surveillance system 100. Selection of the setup button, the small leftmost button marked with an S, ends the live viewing mode 1000 and enters the system setup 808 as shown in FIG. 9. In the system setup 808, as discussed previously, the user can, for example, set camera and recording configurations. Selection of the search button, the large middle button marked with an S, ends the live viewing mode 1000 and enters the search/playback mode 1200 as shown in FIG. 9. In the search/playback mode, the user can search for and view previously recorded video segments, as discussed further below with reference to FIG. 7 and FIG. 12. Selection of the web button, the small rightmost button marked with a W, opens an Internet brower and provides access to the company website. In an alternative embodiment, the rightmost button is not a web button, but is instead a panic button, marked with a P. Selection of the panic button enters the panic mode of record mode 1100 as shown in FIG. 9. In the panic mode, all activated cameras immediately record, as discussed further below with reference to FIG. 11.

The viewing window 602A displays 1006 the video data feed coming from the camera 102A. A message, shown here in the upper left corner of the viewing window 602A, displays the name of the camera 102A being monitored, for example, “C1 Camera 1,” and the current status of the camera 102A, for example, “(Live).” If the camera 102A is instead recording, the message will display “(Rec)” in place of “(Live).” The location of the message text can be set by the user.

The multiple camera view selectors 606 include three buttons that allow the user to select a format for the viewing window 602A. The GUI for the live viewing mode 1000 can display 1006 video data from the cameras 102A-102N in three different formats-one, four, or six images tiled together. As cameras 102A-102N are discovered via the UPnP protocol, the live viewing mode 1000 automatically selects the layout for the viewing window 602A-602C that accommodates that number of cameras 102A-102N. The user can override this selection manually, using the multiple camera view selectors 606 to select another layout mode. Selection, for example, by clicking, of the leftmost button, marked with a single box, selects the GUI 600A of FIG. 6A with the single screen viewing window 602A. Selection of the middle button, marked with a quartered box, selects the GUI 600B of FIG. 6B with the four-screen viewing window 602B. Selection of the rightmost button, marked with a six-tiled box, selects the GUI 600C of FIG. 6C with the six-screen viewing window 602C.

Various additional viewing options exist in the four- or six-camera mosaic modes. Using the GUI 600B or the GUI 600C, the user can click on an image from any camera 102A-102N to expand it to fill the viewing window 602B or 602C. Clicking again returns to the multi-image mosaic for the viewing window 602B or 602C. This feature provides a simple mechanism to take a quick, more detailed look at the image from a particular camera 102A-102N. Additionally, the user can right-click on the image from any camera 102A-102N to bring up a context-sensitive menu of possible actions for that particular camera. For example, the user can print the image, eMail the image, look at image statistics, change the name of the camera, or change the camera number for the camera, among other options. In particular, the user can change the order of the cameras 102A-102N in the four- and six-screen view modes by choosing the “change camera order” option and selecting a new number, e.g., 1-6, for the particular camera. That particular camera will then be assigned to the image position associated with the new number, and the camera previously in that position will swap camera numbers with the camera just changed. The order of the cameras 102A-102N can also be changed via system setup 808 using, for example, the Camera tab of the setup program tab screens 506C of the graphical user interface 500C, by changing the camera order number as described above.

Returning to the GUI 600A of FIG. 6A, the message window 610 displays communication data and other information related to the cameras 102A-102N and to the capturing of video segments. The messages are also recorded in a text log file called, for example, Werks Event Log. The control system 112 continually creates the event log file, which is stored, for example, in data storage device 206A of the computing device 116, to keep a record of the sequence of key program flow operations, especially abnormal events. The event log can be used by support personnel to help isolate and fix problems that may occur during normal system operation.

The date/time stamp window 612 displays the current date and time. The format of the display is day of the week, calendar date, running time in the format hours:minutes:seconds, and AM or PM. The current time clock 614 displays the current time in an analog clock format.

The camera activation panel 616 includes a column of easily viewable status indicators for each camera 102A-102N. The GUI 600A shows six such columns for six cameras 102A-102F. In each column, an active camera indicator 618 is highlighted if the respective camera is active. A blue highlight indicates that the camera is active, but eMail alerts have been disabled for that camera. A red highlight indicates that the camera is active, and eMail alerts are set up and enabled. Left-clicking on the active camera indicator 618 toggles the enabling or disabling of eMail alerts for the particular camera. A representation of a green light emitting diode (LED) 620 is illuminated if the camera connection is good and the camera is sending video data. A representation of a red LED 622 is illuminated if the video data is currently being recorded to disk. An on/off button 624 allows the user to activate or deactivate the camera. As shown in FIG. 6A, the status indicators for camera 102A indicate that the camera 102A is active, since the active camera indicator 618 is highlighted, the connection 108A to the camera 102A is good and the camera 102A is sending video data, since the green LED 620 is illuminated, but the video data is not being recorded, since the red LED 622 is not illuminated.

Record Mode

FIG. 11 is a flowchart of an exemplary embodiment of a record mode 1100 of the video surveillance system 100 of the present invention. The record mode 1100 of the video surveillance system 100 receives 1102 video data from the cameras 102A-102N over the dual use medium 110. The video data received may be encrypted for additional system security as described above with respect to receiving video data 810 of FIG. 8.

If the record mode 1100 is triggered in a panic mode 1104, for example, by user selection of the panic button in the main screen feature buttons 608 area of the GUI 600A of FIG. 6A, video data received from all active cameras 102A-102N immediately records 1106. For each camera 102A-102N, video data is recorded for a set amount of time, or is recorded uninterrupted until a set amount of time after motion is no longer reported from the camera. In each case, the set amount of time may be, for example, ten seconds.

The record mode 1100 allows the user to view and set the record mode and schedule 1108 for each camera 102A-102N. The video surveillance system 100 provides multiple modes for triggering recording of video files, including, for example, motion-based, continuous, and off. By default, the entire recording schedule for all cameras 102A-102N is initially set to the motion-based mode. Under motion-based recording, each time a particular camera 102A-102N sends a motion detection signal to the control system 112, a minimum of a few seconds, for example, five seconds, of video are recorded for that camera. The recording continues as long as motion is detected and for a small time, for example, five seconds, after motion is no longer detected. As discussed previously, in another embodiment, each of the cameras 102A-102N may only send video data to the computing device 116 over the dual use medium 110 for recording when there is actual motion detected, allowing the video surveillance system 100 to conserve bandwidth when there is no motion detected. Under continuous recording, video data from a camera 102A-102N is recorded during the time periods designated in the recording schedule for that camera, regardless of whether motion is detected or not. Under the off recording mode, no recording of video data from a camera 102A-102N will occur, even if motion is sensed by that camera.

Using the Recording Schedule tab screen of the graphical user interface 500A for performing system setup 808, described previously, the user can independently set the recording mode for each camera 102A-102N. Some cameras 102A-102N may be in motion-based recording mode, while others are in the off or continuous modes. Using the GUI 500A, the user can also independently set the recording schedules for each camera 102A-102N in the off or continuous recording modes by designating certain periods of time during a weekly schedule to be off or to be continuously recording.

The record mode 1100 allows the user to set motion detection zones 1110 for each camera 102A-102N for use in the motion-based recording mode. For each camera 102A-102N, the video surveillance system 100 initially defaults to having the entire camera image serve as an active zone. The user can further refine the motion detection system, however, by designating one or more “zones” for each camera 102A-102N in which motion detection is to be active. In particular, the user can use the Motion Detection tab screen of the GUI 500A of FIG. 5B to limit motion detection to certain areas of a particular camera image. In one embodiment, the user can select a particular camera 102A-102N and then left-click and drag with the mouse in the camera image area to define up to sixteen motion detection zones. When motion is detected in a particular zone, that zone is indicated by drawing the zone rectangle, or other shape, on the image during recording of the video data, to provide a visual indication to the user regarding the location of the motion detection.

As part of setting motion detection zones 1110 for each camera 102A-102N, the video surveillance system 100 may employ an automatic image quality system to automatically adjust video quality within the user defined motion detection zones. Video image parameters that may be adjusted include, for example, focus, contrast, brightness, color, exposure time, and other parameters. Thus, if a user specifies a motion detection zone in a camera 102N, a video-quality-enable property is attached to that motion detection zone that, if enabled, commands the camera 102N to focus on the video quality of that particular motion detection zone. The video-quality-enable feature may be enabled or disabled independently for each user designated motion detection zone of each of the cameras 102A-102N.

As an example, a camera 102N may be installed in a fixed location to monitor a specific area that has lighting conditions that change over the course of the day and night, or with objects moving into and out of the area. Although the camera 102N may be designed to automatically adjust contrast, brightness, exposure, and color in response to the varying lighting conditions on a continuous basis, it defaults to seeking a specific average luminance in the overall picture. Seeking an overall average may be acceptable where the lighting conditions change uniformly throughout the camera image, but it is not necessarily useful where the lighting conditions vary in different regions of the camera image.

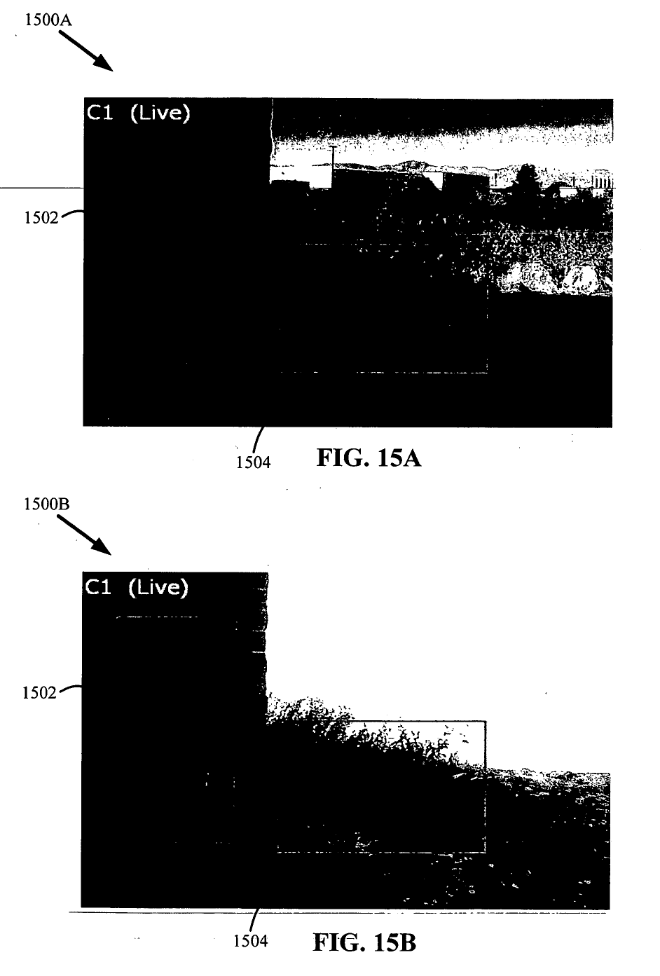

FIGS. 15A and 15B illustrate the advantage achievable with automatic video quality adjustment within user defined motion detection zones. FIG. 15A is a color photograph of a camera image 1500A in which the camera 102N adjusts the image quality based on the camera image 1500A as a whole. Overlaid on the camera image 1500A are a first motion detection zone 1502 and a second motion detection zone 1504, each previously defined by a user. The upper-right region of the camera image 1500A has reasonable quality of brightness, contrast, and color, but the shadowed region created by a building in the foreground is left dark and murky, obscuring the detailed features of a subject moving into the first motion detection zone 1502 and making his identification almost impossible. FIG. 15B is a color photograph of a camera image 1500B in which the camera 102N adjusts the image quality based on the first motion detection zone 1502. In particular, enabling the automatic video quality feature in the first motion detection zone 1502 commands the camera 102N to automatically adjust focus, brightness, contrast, or other image attributes within the first motion detection zone 1502, allowing details of the figure in the first motion detection zone 1502 to be seen.

In an alternative embodiment, each particular user-designated motion detection zone can be assigned one or more specific attributes by the user. Each attribute designates that that motion detection zone is used, or not used, in a particular operation, such as focus, brightness, contrast, color adjustment, etc.

Returning to FIG. 11, the record mode 1100 can operate as a background record mode 1112. The video surveillance system 100 provides the ability to record video data to disk regardless of the operating mode of the system. For example, the video surveillance system 100 can currently be in live viewing mode, or in search/playback mode, or minimized to the Windows® Task Bar, or running only in the Windows® System Tray as a background application. Motion-based video recording, or time-scheduled video recording, continues in any of these modes, as long as the video surveillance system 100 is active.

A significant advantage of the background recording mode 1112 is the resultant low central processing unit (CPU) load. The background recording mode 1112 provides recording capability even while the computing device 116 is being used to perform other tasks. When the user is actively viewing video images, for example, in the live viewing mode 1000 or the search/playback mode 1200, the video rendering can consume a substantial portion of the CPU cycles, depending on the number of cameras 102A-102N being viewed, and the speed of the computing device 116. But when images are not being viewed, such as when the application is minimized or operating in the background recording mode 1112, the CPU usage drops to a very low level, leaving the computing device 116 free to perform other tasks. The video surveillance system 100, on the other hand, continues normal operation: the cameras 102A-102N respond to motion detection events and send video data, the control system 112 receives video data from the cameras 102A-102N, and the computing device 116 records 1114 video data to disk based on motion detection or on the recording schedule calendar.

The computing device 116 controls the recording 1114 of video data to disk according to the mode of each particular camera 102A-102N. Under the motion-based mode, when motion is detected in a particular motion detection zone of a camera 102A-102N, recording begins at the last Key frame, for example, 0-2 seconds before the motion detection event. This is possible through the use of the record queue 402. Under the continuous mode, recording begins at the last Key frame prior to the start time indicated in the recording schedule calendar, also accomplished through use of the record queue 402.

The record mode 1100 optionally displays 1116 recording statistics. If the video surveillance system 100 is simultaneously operating in the record mode 1100 and also either the live viewing mode 1000 or the search/playback mode 1200, the user can view recording statistics by right-clicking in the viewing window, for example, viewing window 602A-602C, and selecting “Recording Statistics” to initiate display 1116 of the recording statistics. If the record mode 1100 is operating in the background recording mode 1112, however, no recording statistics are displayed. Recording statistics may include, for example, record start time, record trigger, recording duration, the number of bytes transferred to a particular file during recording, and/or the average bitrate, among other statistics.

The record mode 1100 also provides support for sending 1118 a notification or video data, for example, by email, to alternative destinations under certain events or conditions. As discussed above with respect to system setup 808 of FIG. 8 and FIG. 5B, the user can specify local email account information and also designate one or more recipients for email notification, via the email tab screen. Having specified desired email destinations, the video surveillance system 100 can automatically send a text message, or a recorded video segment, or the first frame in a segment, or a frame offset by some number of milliseconds from the start of a segment, to the email recipient(s). This mechanism can be used, for example, to notify the user of motion or activity in a remote location, and the user can then connect to the remote video surveillance system 100 and review the recorded video data in further detail.

If the user wishes to change modes 1120, the record mode 1100 terminates, returning the user to the operating process 900 of FIG. 9.

Those skilled in the art will recognize that any number of the steps of the method of FIG. 11 may be performed by the image capture system 106N.

Search/Playback Mode

FIG. 12 is a flowchart of an exemplary embodiment of a search/playback mode 1200 of the video surveillance system 100 of the present invention. Those of skill in the art will appreciate that the modules described in the search/playback mode 1200 of FIG. 12 are not exclusive, need not all be performed in all instances of search/playback, and need not be performed in the order described.

At its most basic, the search/playback mode 1200 includes processes necessary to format 1202 a viewing window, retrieve 1208 video data, and display 1212 that video data in the viewing window. Retrieval 1208 of the video data is facilitated through a search mode calendar 1204 and a search navigation 1206 modules. Display 1212 of the video data is controlled by a video playback navigation 1210 module. Each of these steps is described in greater detail with reference to FIG. 7 below.

The search/playback mode 1200 also optionally displays 1214 playback statistics. The user can view playback statistics by right-clicking in a viewing window, discussed below with reference to FIG. 7, and selecting “Playback Statistics” to initiate display 1214 of the playback statistics, which may include, for example, bitrate, file size, X out of Y bytes played, and/or X out of Y seconds played, among other statistics.

The search/playback mode 1200 also provides support for sending 1216 video data, for example, by email, to alternative destinations under certain events or conditions. As discussed above with respect to system setup 808 of FIG. 8 and FIG. 5B, the user can specify local email account information and also designate one or more recipients for email notification, via the email tab screen. Having specified desired email destinations, the user can manually send the current search-mode image or an excerpt from the current search-mode video clip to the recipient(s). Alternatively, the video data can be sent to a remote viewing location or application via the DirectX RTP source filter 426 and remote viewing data socket 428, or the video data can be sent to an external application via the DirectX RTP source filter 430 and external viewing data socket 432.

If the user wishes to change modes 1218, the search/playback mode 1200 terminates, returning the user to the operating process 900 of FIG. 9.

Those of skill in the art will appreciate that, with minor modifications, the steps of FIG. 12 may also be performed by the image capture system 106N of FIG. 3B, in the case, for example, where camera 102N is equipped with a local display.

FIG. 7 is a graphical representation of an exemplary graphical user interface 700 for a search/playback mode 1200 of one embodiment of the video surveillance system 100 of the present invention. In the search/playback mode 1200, the graphical user interface (GUI) 700 allows a user to accomplish many tasks related to video segments that have been captured and stored, such as searching for and viewing previously recorded video segments, emailing video segments or frames, and deleting video segments or frames, among other functions.

The search/playback mode 1200 GUI 700 is straightforward and intuitive, with a minimum of unnecessary or advanced controls, and includes title bar application options 604, main screen feature buttons 708, a viewing window 702, multiple camera view selectors 606, a message window 610, a calendar icon 712, a calendar 710, a search navigation panel 716, a date/time stamp window 612, and a video playback navigation panel 714.

The title bar application options 604, the multiple camera view selectors 606, and the message window 610 were discussed previously with respect to the live viewing mode 1000 GUI 600A of FIG. 6A and provide the same functionality here.

The main screen feature buttons 708, similar to the main screen feature buttons 608 of the live viewing mode 1000 GUI 600A of FIG. 6A, include three buttons to allow the user to change the operating mode of the video surveillance system 100. Selection of the setup button, the small leftmost button marked with an S, ends the search/playback mode 1200 and enters the system setup 808 as shown in FIG. 9 and discussed previously. Selection of the live viewing button, the large middle button marked with an L, ends the search/playback mode 1200 and enters the live viewing mode 1000 as shown in FIG. 9 and discussed above with reference to FIGS. 6A-6C and FIG. 10. Selection of the web button, the small rightmost button marked with a W, opens an Internet browser and provides access to the company website. As discussed previously, in an alternative embodiment, the rightmost button is not a web button, but is instead a panic button, marked with a P. Selection of the panic button ends the search/playback mode 1200 and enters the panic mode of record mode 1100 as shown in FIG. 9 discussed above with reference to FIG. 11.

The viewing window 702 displays the video data retrieved from the disk storage 406. A message in the upper left corner of the viewing window 702 displays the name of the camera 102A that captured the video data, for example, “C1 Camera 1,” and the current status of the system, for example, “(Search).”

The calendar icon 712 at the lower right corner of the message window 610 allows the user to open or close the calendar 710. The calendar 710, displayed in the message window 610, is one mechanism to simplify the potentially tedious process of reviewing recorded video segments, which may include many clips stored over a long period of time. The calendar 710 may be implemented as a drop-down menu to select from the various months of the year and includes arrow buttons at the top of the calendar 710 to navigate to previous or following months. The current date circled in red. Any dates with recorded video data available are shown bolded. When a particular date is selected, for example, by clicking on it, the playback time is set to the start of the first video clip for that date.

The search navigation panel 716 shows a search timeline displaying the time span of each recorded video clip, for all cameras 102A-102N, at a glance, for the particular date selected on the calendar 710. As an example, the search navigation panel 716 shows available video clips from six cameras as bolded line segments. The user can change the time scale across the top of the search navigation panel 716, with the scale varying from five seconds per division, to four hours per division. This permits the user to see a large time span at a glance, for example, more than a full day, and then to focus in on a particular window of time. With the time line magnified, the user can easily see the start and stop of each recorded video segment. Clicking anywhere in the search navigation panel 116 selects a particular recorded video segment or point in time.

The user can also preview a particular recorded video segment by simply clicking on the timeline to set the playback time, and then dragging the timeline cursor to review the recorded video segment. This provides a mechanism to drag the cursor through a video clip quickly to see what it contains, without actually using the video playback navigation panel 714. Dragging the cursor to the left edge or the right edge of the timeline scale slews the time line in the corresponding direction, making the timeline a virtual endless timeline, with a window of that timeline shown on the search navigation panel 716.

Right clicking in the search navigation panel 716 brings up a context-sensitive menu of possible actions for the recorded video segment. For example, the user can protect or unprotect the video segment, save it under a different filename, delete the video segment, email the video segment or a particular frame, or print the video frame, among other options.

As discussed above, clicking on a particular recorded video segment in the search navigation panel 716 selects that video segment. The date/time stamp window 612 displays the date and time at which the segment of recorded video was captured. The format of the display is day of the week, calendar date, running time in the format hours:minutes:seconds, and AM or PM.

As an intuitive aid to communicate the recording time at a glance, the GUI 700 additionally provides an analog clock 718. To enhance the analog time readout, and to resolve the ambiguity resulting from the 12-hour clock face, the clock face changes color for day or night recording times. Video captured between 6 AM and 6 PM results in a light-colored clock face, while video captured between 6 PM and 6 AM results a dark clock face. The day/night analog clock 718 provides an enhanced human-factors interface to the user while searching through recorded video segments.

The video playback navigation panel 714 enhances the video search functionality with the easy-to-use shuttle control interface, which controls display 1212 of the recorded video data. The video playback navigation panel 714 allows standard play/pause functionality. In one embodiment, the play button toggles between showing play and pause. The video segment can be played in either the forward or reverse direction. In addition, it has a button for single-frame-advance, plus buttons to advance to the next video clip, or to the start of the current clip, or to the start of the previous clip.

Of particular interest is the ability to vary the playback speed of a recorded video segment. The standard Microsoft® DirectX Reader used for viewing Media 9 video streams can only play back video streams at a rate of 1.0×, i.e., normal viewing speed. To overcome this shortcoming, the video surveillance system 100 employs a custom stream reader that provides support for playback speeds slower and faster than 1.0×. Although the custom stream reader can support a variety of rates, in one embodiment, the video playback navigation panel 714 of the GUI 700 provides a range of playback speeds from ⅛× to 8× of normal speed. The playback speed can be varied by rotating, for example, by dragging, the shuttle wheel of the video playback navigation panel 714 clockwise or counter-clockwise to change the playback speed.

Of additional interest is the ability of the video surveillance system 100 to maintain temporal synchronization among multiple cameras 102A-102N during playback of recorded video segments. If standard Microsoft® Readers were used to view the video data from the multiple cameras, it would be difficult to ensure that the several readers maintained temporal synchronization over long periods of playback. One embodiment of the video surveillance system 100, however, includes six cameras, and the viewing window 702 of the GUI 700 for the search/playback mode 1200 includes a six-image mosaic format, similar to the format of the viewing window 602C of the GUI 600C of FIG. 6C for the live viewing mode 1000. The search/playback mode 1200 controls the individual readers for each camera 102A-102N, i.e., the playback graph filters 408, such that each reader displays 1212 each video frame in the viewing window 702 of the GUI 700 according to a master system playback time, common to all readers.

Video Surveillance Camera

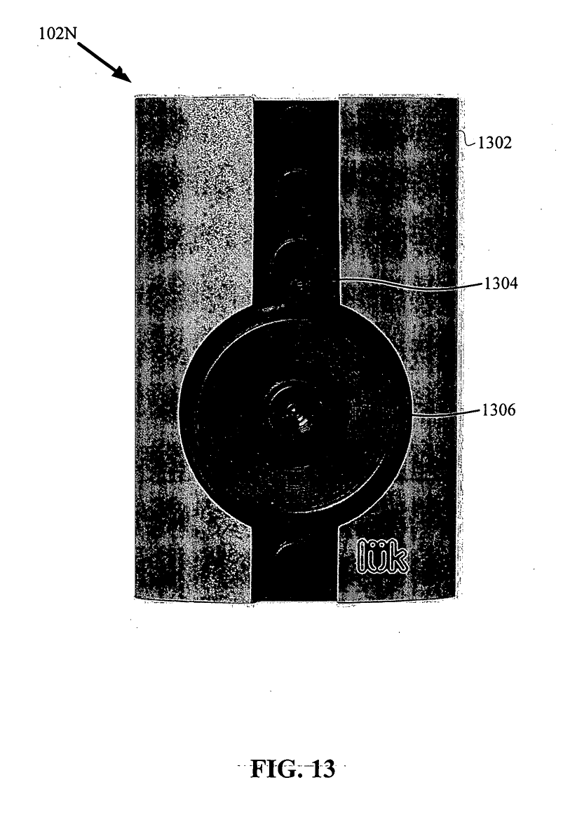

FIG. 13 is a perspective view of one embodiment of a video surveillance camera 102N of the present invention. A camera lens 1306 is positioned at the center of a concave surface that is encased in a hard plastic shell 1302. The shell 1302 of the camera is designed to provide a low profile camera that is not obvious to the casual observer. Light emitting diode (LED) status lights visible through the camera housing show whether the connection is active, whether the camera is functioning, and whether the camera recording. A record status light 1304 is shown illuminated on the camera 102N in FIG. 13.

The camera 102N can be placed on any flat and stable surface, such as a window sill, bookshelf, or on top of a bureau or desk or other item of furniture. Alternatively, a suction cup (not shown) can be attached to the back or front of the camera 102N to facilitate mounting the camera 102N to, for example, a window. If the suction cup is mounted to the back of the camera 102N, the camera's lens 1306 can be directed into the interior of the building or house. Mounting the suction cup on the front of the camera 102N allows directing the camera lens 1306 to monitor a zone outside of the building through a window, for example. Alternatively, a wall or ceiling mount may be provided for the camera 102N.

FIG. 14 is a block diagram of the components 1400 of the video surveillance camera 102N. A wall/ceiling mount 1402 physically attaches the camera 102N to a vertical surface or to a ceiling. The wall/ceiling mount 1402 may be, for example, a suction cup that attaches the camera 102N to a window. Alternatively, as shown in FIG. 13, the camera 102N may be free-standing on a horizontal surface.

A video sensor 1414, for example, a CMOS or CCD device, captures video frames from a camera optics system 1416, including the lens 1306, for processing by a main camera board 1412. The video sensor 1414 and the camera optics system 1416 form the basis for the input video device 222 of FIG. 2. The video sensor 1414, the camera optics system 1416, and the main camera board 1412 form the basis of the image capture system 106N of FIG. 1, which may also include the optional data storage device 206B.

The main camera board 1412 includes, for example, the processor 202B and the main memory 204B, which are used to control operation of the camera 102N via the modules in the main memory 204B shown in FIG. 3B. For example, the video data signal is prepared for transmission via the dual use medium 110 by the send data module 308B, or for storage in the data storage 206B by the record module 312B. In particular, the main camera board 1412 performs dynamic or static bandwidth control, and network packetization to stream the video to a remote viewing client. The video surveillance system 100, however, also moves some of the compute-intensive tasks involved in video processing into the camera 102N, thus freeing the processing resources of the computing device 116 for other normal tasks, such as word processing and spreadsheet applications. In particular, the main camera board 1412 also performs one or more of the following compute-intensive tasks: digitizing analog video, compressing digitized video before transmission or storage using the image compression module 324, and motion detection using the motion detection module 322.

The transceiver 104N couples the camera 102N to the dual use medium 110. In the embodiment of FIG. 14, the dual use medium 110 is a 120V power line, and the transceiver 104N includes a power supply 1406 and a power line adapter 1422. The power supply 1406 converts the 120V power line signal, provided via a power portion 110A of the dual use medium 110, to the required operating voltage of the camera 102N. Alternatively, the camera 102N may be suspended, via the wall/ceiling mount 1402, from a track lighting system. In such an embodiment, the path to the dual use medium 110 may be through the wall/ceiling mount 1402, as depicted by the dashed lines between the dual use medium 110, the wall/ceiling mount 1402, and the power supply 1406. In such an embodiment, the same path would be used for data communications instead of line 110. The power line adapter 1422 facilitates transmission of the video data over a data portion 110B of the dual use medium 110 via an Ethernet-type, or other digital data connection. Alternatively, a wireless modem 1418 may be supplied to transmit the video data wirelessly to the control system 112.

The camera 102N also includes a motion detector 1408, which indicates each frame in which there is motion. An infrared emitter 1410 facilitates infrared reflection operation. A set of status LEDs 1420 shows the status of the camera 102N, for example, whether the connection 108N to the dual use medium 110 is active, whether the camera 102N is functioning, and whether the camera 102N is recording. For example, if the connection 108N is active, green and yellow LEDs are on, and if the camera 102N is recording, a red LED is on.

The camera 102N also optionally includes a back-up battery pack 1404 to provide power to the camera 102N in the event of failure of the 120V power supply. In particular, the back-up battery pack 1404 provides the basis for a back-up system for fault tolerance. If the 120V power to the camera 102N fails or is turned off, the camera 102N hibernates, but the motion detector 1408 continues to operate. A motion-based event triggers the camera 102N to power up, using the back-up battery pack 1404, and to transmit video to the control system 112, either wirelessly via the wireless modem 1418 or through power line communication via the power line adapter 1422 of the transceiver 104N. Alternatively, the data storage 206B, for example, a FLASH memory device, may be used to store, and later download, video segments recorded during power-down conditions. This ensures reliable surveillance under all conditions.

Those of skill in the art will appreciate that alternative embodiments of the camera 102N may not include all of the components 1400 shown in FIG. 14, or that additional components not shown in FIG. 14 may also be present in camera 102N. For example, the camera 102N may optionally include a panic button for recording in a local panic mode as discussed previously. Additionally, the camera 102N may include a local display to facilitate operation of live viewing, record, and search/playback modes in accordance with a memory 204B of the camera 102N, as discussed previously.

The video surveillance system of the present invention preserves the advantages of traditional video surveillance while overcoming many of its deficiencies by providing a low cost, user friendly, multi-functional video surveillance system that is responsive to real-time viewing requirements, and yet requires low CPU processing resources thereby preventing interference with other computer tasks.

Upon reading this disclosure, those of skill in the art will appreciate additional alternative structural and functional designs for systems and processes for video surveillance through the disclosed principles of the present invention. Thus, while particular embodiments and applications of the present invention have been illustrated and described, the invention is not limited to the precise construction and components disclosed herein and various modifications, changes and variations, which will be apparent to those skilled in the art, may be made in the arrangement, operation, and details of the methods and apparatus of the present invention disclosed herein without departing from the spirit and scope of the invention as defined in the appended claims.

1. A video surveillance system comprising:
a dual use medium;
a first camera having a camera transceiver communicatively coupled to the dual use medium, the camera transceiver configured to send video data captured by the first camera over the dual use medium and to receive control signals over the dual use medium; and
a control system having a control transceiver communicatively coupled to the dual use medium for a low latency video connection with the first camera, the control transceiver configured to receive video data from the first camera via the dual use medium and to send control signals to the first camera over the dual use medium.

2. The system of claim 1, wherein the dual use medium is a building power line.

3. The system of claim 1, further comprising a second camera having a second transceiver communicatively coupled to the dual use medium, the second camera transceiver configured to send video data from the second camera over the dual use medium and to receive control signals over the dual use medium.

4. The system of claim 1, wherein the first camera further comprises:
an image capture system for generating a video signal; and
a processor coupled to the image capture system, the processor creating a video data stream from the video signal, the processor including a motion detection module for analyzing the video data stream and indicating a segment of the video data stream in which a motion-based event occurred.

5. The system of claim 4, wherein the camera transceiver further comprises:
an adapter having an input and an output for sending and receiving data signals over the dual use medium, the input of the adapter coupled to the dual use medium, and the output of the adapter coupled to the processor; and
a power supply having an input and an output for converting power, the input of the power supply coupled to the dual use medium, the output of the power supply coupled to the processor.

6. The system of claim 1, wherein the first camera further comprises a module coupled to the camera transceiver, the module performing one function from the group of digitizing analog video, compressing digitized video, and performing motion detection.

7. The system of claim 1, wherein the control system further comprises a set up module having an input and an output for initializing the video surveillance system, the input of the set up module coupled to the first camera to receive status input and coupled to receive user input, and the output coupled to provide signals indicating initial system parameters.

8. The system of claim 1, wherein the control system further comprises a camera discovery module for detecting a presence of the first camera, the camera discovery module having an input coupled to the first camera, and an output providing a signal indicating communication with the first camera is established.

9. The system of claim 1, wherein the control system further comprises a receive data module for converting video data from a format used to transmit over the dual use medium into a format for processing by the control system, the receive data module coupled to the dual use medium.

10. The system of claim 9, wherein the receive data module performs decryption of the video data received from the dual use medium.

11. The system of claim 1, wherein the control system further comprises a processing unit for processing data received over the dual use medium, and a storage device for temporarily storing data received over the dual use medium, the processing unit coupled to the storage device and the dual use medium.

12. The system of claim 11, wherein the control system further comprises a live viewing module coupled to the processing unit for outputting video data substantially contemporaneous with when the video data is captured by the first camera.

13. The system of claim 12, wherein the live viewing module is also adapted to facilitate activation and deactivation of the first camera, change the viewing window format, change system parameters, set motion detection zones, or access other modes of operation.

14. The system of claim 11, wherein the control system further comprises a record module coupled to the processing unit for storing the video data received over the dual use medium.

15. The system of claim 11, wherein the control system further comprises a search/playback module coupled to the processing unit for allow searching and playback of previously recorded video data.

16. The system of claim 11, wherein the control system further comprises a remote viewing module coupled to the processing unit to facilitate remote viewing of the video data received over the dual use medium.

17. The system of claim 11, wherein the control system further comprises an external applications module coupled to the processing unit for sending of the video data received over the dual use medium to devices external to the control system.

18. A method of operating a video surveillance system, the method comprising:
establishing a low latency video connection over a dual use medium by a control system;
receiving a signal from the dual use medium;
processing the received signal to produce a video data signal; and
outputting the video data signal.

19. The method of claim 18, wherein outputting is performed by generating a display using the video data signal, and wherein the step of generating is performed relatively contemporaneously with the step of receiving.

20. The method of claim 18, wherein establishing a low latency video connection further comprises:
examining a computer environment; and
customizing parameters of the video surveillance system based on the computer environment.

21. The method of claim 18, wherein establishing a low latency video connection further comprises automatically detecting a coupling of a camera to the dual use medium.

22. The method of claim. 18, wherein establishing a low latency video connection further comprises responsive to a breaking of the low latency video connection, automatically reestablishing the low latency video connection with the camera.

23. The method of claim 18, wherein establishing a low latency video further comprises:
determining if a firewall is preventing a proper operation of the video surveillance system;
determining a type of traffic being blocked by the firewall;
displaying a notification of the presence of the firewall; and
suggesting reconfiguration steps to allow the proper operation of the video surveillance system

24. The method of claim 18, further comprising automatically restarting operation of the video surveillance system at a time set by a user or a predefined period of inactivity.

25. The method of claim 18, wherein the step of outputting the video data signal includes storing the signal on a storage device.

26. The method of claim 18, wherein the step of outputting the video data signal includes storing the signal on a storage device, and responsive to input from the user searching and displaying the video data signal to the user.

27. The method of claim 18, wherein the step of processing the video data signal includes:
receiving encrypted video data from the dual use medium; and
decrypting the encrypted video data using an encryption key set by a user.

28. The method of claim 18, wherein outputting the video data signal comprises distributing the video data to one from the group of an external application and a remote viewing connection.

29. The method of claim 18, further comprising displaying a graphical user interface for control of the video surveillance system, the graphical user interface allowing formatting of a viewing window, displaying video data in the viewing window, displaying a camera status indicators, and allowing activation or deactivation of a camera.

30. The method of claim 18, wherein receiving a signal from the dual use medium further comprises receiving a first signal corresponding to a first camera, and receiving a second signal corresponding to a second camera, and wherein outputting the video data signal includes displaying a first image corresponding to the first signal and a second image corresponding to the second signal.

31. The method of claim 18, further comprising displaying a panic button, and wherein user selection of the panic button causes the control system to record signals received over the dual use medium.

32. The method of claim 25, further comprising
receiving user designation of a time period;
receiving user designation of a recording mode for the time period; and
performing the step of storing according to the time period and the recording mode received.

33. The method of claim 18, further comprising setting a motion detection zone for the signal received over the dual use medium.

34. The method of claim 33, wherein the motion detection zone is a portion of a view of the signal received over the dual use medium.

35. The method of claim 33, further comprising adjusting video image quality based on the motion detection zone.

36. The method of claim 25, further comprising:
determining an amount of storage space available on the storage device; and
if an amount of space required to store the video data exceeds the amount of storage space available on the storage device, deleting an oldest non-protected video file stored on the storage device.

37. The method of claim 18, further comprising:
displaying a search/playback graphical user interface;
displaying a representation of a first video segment on the search/playback graphical user interface, the first video segment previously recorded from video data received over the dual use medium;
selecting the representation of the first video segment;
retrieving the first video segment; and
displaying the first video segment in a viewing window of the search/playback graphical user interface.

38. The method of claim 37, wherein displaying a search/playback graphical user interface comprises:
displaying a calendar indicating a date having the first video segment available;
displaying a variable scale timeline, wherein the representation of the first video segment is displayed on the timeline to show duration of the first video segment; and
previewing the first video segment responsive to user selection of the representation of the first video segment.

39. The method of claim 37, further comprising:
displaying a representation of a second video segment on the search/playback graphical user interface, the second video segment previously recorded from video data received over the dual use medium;
selecting the representation of the second video segment;
retrieving the second video segment;
displaying the second video segment in the viewing window of the search/playback graphical user interface simultaneously with the first video segment; and
maintaining a temporal synchronization between display of the first video segment and display of the second video segment.

40. The method of claim 18, further comprising sending a notification to a recipient, the notification responsive to a trigger.

41. A video surveillance camera, the camera comprising:
an image capture system for generating a video signal;
a processor coupled to the image capture system, the processor creating a video data stream from the video signal, the processor including a motion detection module for analyzing the video data stream and indicating a segment of the video data stream in which a motion-based event occurred; and
a transceiver having a first input/output and a second input/output, for sending the video data stream, the first input/output coupled to the processor and the second input/output adapted for connection to a dual use medium.

42. The video surveillance camera of claim 41, wherein the video signal output by the image capture system is an analog signal, and wherein the video surveillance camera further comprises a digitizing module for converting the video signal to a digital video signal, the digitizing module coupled to the image capture system and the processor.

43. The video surveillance camera of claim 41, further comprising a compressing module for generating a compressed digital video signal from the video signal, the compressing module coupled to the image capture system to receive the video signal and to the processor to output the compressed digital video signal.

44. The video surveillance camera of claim 41, further comprising a battery for providing power, the battery coupled to the processor.

45. The video surveillance camera of claim 41, further comprising a data storage device coupled to the processor.

46. The video surveillance camera of claim 41, wherein the transceiver further comprises:
an adapter having an input and an output for sending and receiving data signals over a power line, the input of the adapter forming the second input/output of the transceiver, and the output of the adapter coupled to the processor; and
a power supply having an input and an output for converting power, the input of the power supply coupled to the input of the adapter and forming the second input/output, the output of the power supply coupled to the processor.
